(19) United States
(12) Patent Application Publication
(10) Pub. No.: US 2024/0392055 A1
(43) Pub. Date: Nov. 28, 2024

(54) UV/HEVL-FILTERING SILICONE HYDROGEL CONTACT LENSES

(71) Applicant: Alcon Inc., Fribourg (CH)

(72) Inventors: Troy Vernon Holland, Suwanee, GA (US); Adam K. Sniady, Lilburn, GA (US); Frank Chang, Cumming, GA (US)

(21) Appl. No.: 18/665,682

(22) Filed: May 16, 2024

Related U.S. Application Data
(60) Provisional application No. 63/503,030, filed on May 18, 2023.

(51) Int. Cl. C08F 230/08; B29D 11/00; B29K 83/00; B29K 105/00; G02B 1/04; G02C 7/10

(52) U.S. Cl. CPC C08F 230/08; B29D 11/00076; G02B 1/043; G02C 7/104; B29K 2083/00; B29K 2105/0032; B29K 2105/0061; B29K 2995/0026; B29K 2995/0046; B29K 2995/0065; C08F 2800/20

(57) ABSTRACT

Described herein is a UV/HEVL-filtering SiHy contact lens that not only has a relatively high UV/HEVL filtering capability but also has an aesthetic appealing color. The bulk silicone hydrogel of the UV/HEVL-filtering SiHy contact lens comprises repeating units of (1) at least one hydrophilic vinylic monomer, (2) at least one siloxane-containing vinylic monomer and/or at least one polysiloxane vinylic crosslinker, (3) at least one UV-absorbing vinylic monomer having an absorption peak at a wavelength of from 280 nm and 380 nm, (4) a first HEVL-absorbing benzotriazole-containing vinylic monomer having an absorption peak at a wavelength of from 410 nm and 420 nm, (5) a second HEVL-absorbing benzotriazole-containing vinylic monomer having an absorption peak at a wavelength of from 415 nm and 425 nm, and (6) from about 90 ppm to about 300 ppm of repeating units of at least one polymerizable blue dye.

This application claims the benefit under 35 USC § 119 (e) of U.S. provisional application No. 63/503,030 filed 18 May 2023, herein incorporated by reference in its entirety.

This invention is related to a method for making contact lenses, preferably silicone hydrogel contact lens, capable of significantly filtering UV lights and high-energy visible lights (HEVL) with wavelengths from 380 nm to 450 nm and related to contact lenses produced according to a method of the invention.

### BACKGROUND

LED lights and electronic device, including smart phones, computer screens, LCD and LED televisions, have been extensively used. They typically can emit short wavelength visible light, including violet light (380-450 nm) and blue light (450-495 nm). Such short wavelength visible lights were shown to be damaging to cells both in in vitro and in vivo studies reported in Experimental Eye Research 2006, 83, 1493; J. Cataract Refrac Surg 2009, 35, 354; Graefe's Arch Clin Exp Ophthalmol 2008, 246, 671; Acta Ophthalmologica Scandinavica 2006, 84, 4; Br J Ophthalmol 2006, 90, 784; Optometry and Vision Science 2011, 88(6), 1. A great effort has been made to develop HEVL-filtering ophthalmic lenses, such as, spectacles, contact lenses, intraocular lenses, etc. to protect eyes from increasing exposures of HEVL due to widely use of LED lights and LED displays, e.g., smart phone, TV and computer monitor (see, e.g., U.S. Pat. Nos. 4,612,358, 4,528,311, 4,716,234, 4,878,748, 5,400,175, 5,662,707, 6,158,862, 6,955,430, 7,556,376, 7,803,359, 8,153,703, 8,232,326, 8,360,574, 8,585,938, 8,882,267, 9,377,569, 9,683,102, 9,814,658, 10551637, and 10610472; U.S. Pat. Appl. Pub. Nos. 20170242274, 20180371139, 20190002415, 20190002459, 20190271798, 20190339544, 20200002267, 20200095187, 20200407324, and 20200407337).

TOTAL30® (from Alcon) is the first contact lens to offer HEVL-filtering capability that is constantly in effect while wearing the lenses regardless of the lighting conditions. TOTAL30® not only includes Class I UV absorption for protection against UVA and UVB rays (i.e., filtering more than 90% UVA and 99% UVB rays), but also can filter out approximately 33% of HEVL rays entering the eye (between 380-450 nm). Alcon subsequently launched a second product, TOTAL1®, which like TOTAL30® can block 90% UVA, 99% UVB, and 33% HEVL. Johnson & Johnson Vision Care recently also launched ACUVUE® OASYS MAX 1-DAY which can block up to 45% HEVL according to its published 510(k) Premarket Notification (K210930).

It would still be desirable to have a contact lens product with HEVL-filtering capability much higher than currently available commercial contact lenses to better protect wears' eyes from HEVL damages, especially violet light damages. However, it is quite a challenging to find a suitable polymerizable HEVL-absorbing dye that can absorb a significant amount of HEVL light and have a good solubility in a lens-forming composition, a good compatibility with other polymerizable components in the lens-forming composition, and a good light fastness. Furthermore, an increase in loading HEVL absorber in a contact lens would negatively affect the aesthetic appearance of the contact lens, making it more unappealingly yellow. Although addition of a reactive blue dye (e.g., RB246 or RB247) could offset yellow color of the contact, it will contribute to increased darkness of the contact lens.

Therefore, there is need for contact lenses, especially silicone hydrogel contact lens, capable of significantly filtering HEVL and such high HEVL-filtering contact lenses.

### SUMMARY OF THE INVENTION

The invention provides a UV/HEVL-filtering contact lens, comprising a bulk silicone hydrogel material that comprises: (1) repeating units of at least one hydrophilic vinylic monomer; (2) repeating units of at least one silicone-containing vinylic monomer and/or at least one polysiloxane vinylic crosslinker; (3) repeating units of at least one UV-absorbing vinylic monomer having an UV absorption peak at a wavelength of from 280 nm and 380 nm; (4) repeating units of a first HEVL-absorbing benzotriazole vinylic monomer having a first HEVL absorption peak at a wavelength of from 410 nm and 420 nm; (5) repeating units of a second HEVL-absorbing benzotriazole vinylic monomer that has a second HEVL absorption peak at a wavelength of from 415 nm and 425 nm, wherein the wavelength of the second HEVL absorption peak is longer than the wavelength of the first HEVL absorption peak; and (6) from about 90 ppm to about 300 ppm of repeating units of at least one polymerizable blue dye which is reactive blue 247 (1,4-bis((2-methoxyethyl)amino)-anthraquinone) and/or reactive blue 246 (1,4-bis(4-(2-methacryloxyethyl)phenylamino)-anthraquinone), wherein said components (3), (4) and (5) are present in the bulk hydrogel material in amounts and at a ratio for rendering the UV/HEVL-filtering contact lens to have a UVA % T of less than 5%, UVB % T of about 1% or less, a HEVL % T of about 35% or less, a % T at 410 nm of about 15% or less, a % T at 430 nm of about 60% or less, and a % T at 450 nm of about 90% or greater, wherein the UV/HEVL-filtering contact lens has a color expressed with a*≤−5 and b*≤+18.

### BRIEF DESCRIPTIONS OF THE DRAWINGS

FIG. 1 shows the UV/visible transmission spectra (A) and absorption spectra (B) of dilute solutions of 3 HEVL-absorbing benzotriazole-containing vinylic monomers (UV29, UV28 and UV23 as measured in a 1 cm cuvette: Curve 1—40 ppm UV29; Curve 2—40 ppm UV28; Curve 3—40 ppm UV23.

FIG. 2 shows the UV/visible transmission spectra of HEVL-filtering SiHy contact lenses (−3.0 D): Curve 1—Precision1 (HEVL % T=95%); Curve 2—DAILIES TOTAL1 for Astigmatism (HEVL % T=67%); Curve 3—1.8% Norbloc & 1.5% UV28 (HEVL % T=35%); and Curve 4-1.8% Norbloc & 1.5% UV23 (HEVL % T=28%).

FIG. 3 shows the UV/visible transmission spectra of HEVL-filtering SiHy contact lenses (−3.0 D): Curve 1—Precision1 (HEVL % T=95%); Curve 2—DAILIES TOTAL1 for Astigmatism (HEVL % T=67%); Curve 3—1.8 Norbloc, 1.0% UV28 & 0.75% UV23 (HEVL % T=35%); and Curve 4—1.8% Norbloc, 1.25% UV28 & 0.75 wt % UV23 (HEVL % T=28%).

FIG. 4 shows the X-rite color measurements of HEVL-filtering SiHy contact lenses (−3.0 D). The 1^{st}, 2^{nd} and 3^{rd} numeric numbers next to each dots represent the amounts of UV23 (wt %), UV28 (wt %) and RB247 (ppm).

FIG. 5 shows the UV/visible transmission spectra of HEVL-filtering SiHy contact lenses (−3.0 D): Curve 1—lens formulation 5-1; Curve 2—lens formulation 5-2; Curve 3—lens formulation 5-3; Curve 4—lens formulation 5-4; and Curve 5—lens formulation 5-5.

### DETAILED DESCRIPTION OF THE INVENTION

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well known and commonly employed in the art.

“About” as used herein means that a number referred to as “about” comprises the recited number plus or minus 1-10% of that recited number.

“Optional” or “optionally” means that the subsequently described event or circumstance can or cannot occur, and that the description includes instances where the event or circumstance occurs and instances where it does not.

An “ophthalmic device”, as used herein, refers to a contact lens (hard or soft), an intraocular lens, a corneal onlay, other ophthalmic devices (e.g., stents, glaucoma shunt, or the like) used on or about the eye or ocular vicinity.

“Contact Lens” refers to a structure that can be placed on or within a wearer's eye. A contact lens can correct, improve, or alter a user's eyesight, but that need not be the case. A contact lens can be of any appropriate material known in the art or later developed, and can be a soft lens, a hard lens, or a hybrid lens.

A “hydrogel contact lens” refers to a contact lens comprising a hydrogel bulk (core) material. A hydrogel bulk material can be a non-silicone hydrogel material or preferably a silicone hydrogel material.

A “hydrogel” or “hydrogel material” refers to a crosslinked polymeric material which has three-dimensional polymer networks (i.e., polymer matrix), is insoluble in water, but can hold at least 10% by weight of water in its polymer matrix when it is fully hydrated (or equilibrated).

A siloxane, which often also described as a silicone, refers to a molecule having at least one moiety of —Si—O—Si— where each Si atom carries two organic groups as substituents.

A “silicone hydrogel” or “SiHy” refers to a silicone-containing hydrogel obtained by copolymerization of a polymerizable composition comprising at least one silicone-containing monomer or at least one silicone-containing macromer or at least one crosslinkable silicone-containing prepolymer.

As used in this application, the term “non-silicone hydrogel” refers to a hydrogel that is theoretically free of silicon.

“Hydrophilic,” as used herein, describes a material or portion thereof that will more readily associate with water than with lipids.

The term “room temperature” refers to a temperature of about 22° C. to about 26° C.

The term “soluble”, in reference to a compound or material in a solvent, means that the compound or material can be dissolved in the solvent to give a solution with a concentration of at least about 0.5% by weight at room temperature (i.e., a temperature of about 22° C. to about 26° C.).

The term “insoluble”, in reference to a compound or material in a solvent, means that the compound or material can be dissolved in the solvent to give a solution with a concentration of less than 0.01% by weight at room temperature (as defined above).

A “vinylic monomer” refers to a compound that has one sole ethylenically unsaturated group, is soluble in a solvent, and can be polymerized actinically or thermally.

The term “ethylenically unsaturated group” is employed herein in a broad sense and is intended to encompass any groups containing at least one >C═CH₂ group. Exemplary ethylenically unsaturated groups include without limitation (meth)acryloyl

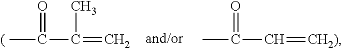

vinyloxycarbonylamino

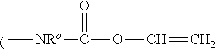

in which R^{o} is H or C₁-C₄ alkyl), vinyloxycarbonyloxy

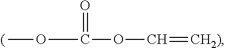

allyl, vinyl, styrenyl, or other C═C containing groups.

As used herein, “actinically” in reference to curing, crosslinking or polymerizing of a polymerizable composition, a prepolymer or a material means that the curing (e.g., crosslinked and/or polymerized) is performed by actinic irradiation, e.g., UV/visible light irradiation, or the like. Thermal curing or actinic curing methods are well-known to a person skilled in the art.

An “acrylic monomer” refers to a vinylic monomer having one sole (meth)acryloyl group.

Examples of acrylic monomrs includes (meth)acryloxy [or (meth)acryloyloxy] monomers and (meth)acrylamido monomers.

An “(meth)acryloxy monomer” or “(meth)acryloyloxy monomer” refers to a vinylic monomer having one sole group of

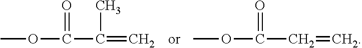

An “(meth)acrylamido monomer” refers to a vinylic monomer having one sole group of

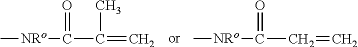

in which R^{o} is H or C₁-C₄ alkyl.

The term “(meth)acrylamide” refers to methacrylamide and/or acrylamide.

The term “(meth)acrylate” refers to methacrylate and/or acrylate.

An “N-vinyl amide monomer” refers to an amide compound having a vinyl group (—CH≡CH₂) that is directly attached to the nitrogen atom of the amide group.

The term “ene group” refers to a monovalent radical of CH₂═CH— or CH₂═CCH₃— that is not covalently attached to an oxygen or nitrogen atom or a carbonyl group.

An “ene monomer” refers to a vinylic monomer having one sole ene group.

A “vinyloxycarbonylamino monomer” refers to a vinylic monomer having one sole vinyloxycarbonylamino group.

A “vinylaminocarbonyloxy monomer” refers to a vinylic monomer having one sole vinylaminocarbonyloxy group.

A “vinylaminocarbonylamino monomer” refers to a vinylic monomer having one sole vinylaminocarbonylamino group.

A “hydrophilic vinylic monomer” refers to a vinylic monomer which typically yields a homopolymer that is water-soluble or can absorb at least 10 percent by weight of water.

A “hydrophobic vinylic monomer” refers to a vinylic monomer which typically yields a homopolymer that is insoluble in water and can absorb less than 10% by weight of water.

As used in this application, the term “vinylic crosslinker” refers to an organic compound having at least two ethylenically unsaturated groups. A “vinylic crosslinking agent” refers to a vinylic crosslinker having a molecular weight of 700 Daltons or less.

An “acrylic crosslinker” refers to a vinylic crosslinker having at least two (meth)acryloyl groups.

The term “acrylic repeating units” refers to repeating units of a polymeric material, each of which is derived from an acrylic monomer or crosslinker in a free-radical polymerization to form the polymeric material.

The term “terminal (meth)acryloyl group” refers to one (meth)acryloyl group at one of the two ends of the main chain (or backbone) of an organic compound as known to a person skilled in the art.

As used in this application, the term “polymer” means a material formed by polymerizing/crosslinking one or more monomers or macromers or prepolymers or combinations thereof.

A “macromer” or “prepolymer” refers to a compound or polymer that contains ethylenically unsaturated groups and has a number average molecular weight of greater than 700 Daltons.

As used in this application, the term “molecular weight” of a polymeric material (including monomeric or macromeric materials) refers to the number-average molecular weight unless otherwise specifically noted or unless testing conditions indicate otherwise. A skilled person knows how to determine the molecular weight of a polymer according to known methods, e.g., GPC (gel permeation chromatography) with one or more of a refractive index detector, a low-angle laser light scattering detector, a multi-angle laser light scattering detector, a differential viscometry detector, a UV detector, and an infrared (IR) detector; MALDI-TOF MS (matrix-assisted laser desorption/ionization time-of-flight mass spectroscopy); ¹H NMR (Proton nuclear magnetic resonance) spectroscopy, etc.

A “polysiloxane segment” or “polydiorganosiloxane segment” interchangeably refers to a polymer chain segment (i.e., a divalent radical) of

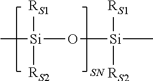

in which SN is an integer of 3 or larger and each of R_{S1} and R_{S2} independent of one another are selected from the group consisting of: C₁-C₁₀ alkyl; phenyl; C₁-C₄-alkyl-substituted phenyl; C₁-C₄-alkoxy-substituted phenyl; phenyl-C₁-C₆-alkyl; C₁-C₁₀ fluoroalkyl; C₁-C₁₀ fluoroether; aryl; aryl C₁-C₁₈ alkyl; -alk-(OC₂H₄)_{γ1}—OR^{o} (in which alk is C₁-C₆ alkylene diradical, R^{o} is H or C₁-C₄ alkyl and γ1 is an integer from 1 to 10); a C₂-C₄₀ organic radical having at least one functional group selected from the group consisting of hydroxyl group (—OH), carboxyl group (—COOH), amino group (—NR_{N1}R_{N1}′), amino linkages of —NR_{N1}—, amide linkages of —CONR_{N1}—, amide of —CONR_{N1}R_{N1}′, urethane linkages of —OCONH—, and C₁-C₄ alkoxy group, or a linear hydrophilic polymer chain, in which R_{N1} and R_{N1}′ independent of each other are hydrogen or a C₁-C₁₅ alkyl; and a photochromic organic radical having a photochromic group.

A “polydiorganosiloxane vinylic monomer” or “polysiloxane vinylic monomer” interchangeably refers to a compound comprising at least one polysiloxane segment and one sole ethylenically-unsaturated groups.

A “polydiorganosiloxane vinylic crosslinker” or “polysiloxane vinylic crosslinker” interchangeably refers to a compound comprising at least one polysiloxane segment and at least two ethylenically-unsaturated groups.

A “linear polydiorganosiloxane vinylic crosslinker” or “linear polysiloxane vinylic crosslinker” interchangeably refers to a compound comprising a main chain which includes at least one polysiloxane segment and is terminated with one ethylenically-unsaturated group at each of the two ends of the main chain.

A “chain-extended polydiorganosiloxane vinylic crosslinker” or “chain-extended polysiloxane vinylic crosslinker” interchangeably refers to a compound comprising at least two ethylenically-unsaturated groups and at least two polysiloxane segments each pair of which are linked by one divalent radical.

The term “fluid” as used herein indicates that a material is capable of flowing like a liquid.

As used in this application, the term “clear” in reference to a polymerizable composition means that the polymerizable composition is a transparent solution or liquid mixture having a light transmissibility of 85% or greater (preferably 90% or greater) in the range between 400 to 700 nm.

A free radical initiator can be either a photoinitiator or a thermal initiator. A “photoinitiator” refers to a chemical that initiates free radical crosslinking/polymerizing reaction by the use of light. A “thermal initiator” or “thermal free radical initiator” interchangeably refers to a chemical that initiates free radical crosslinking/polymerizing reaction by the use of heat energy.

The term “monovalent radical” refers to an organic radical that is obtained by removing a hydrogen atom from an organic compound and that forms one bond with one other group in an organic compound. Examples include without limitation, alkyl (by removal of a hydrogen atom from an alkane), alkoxy (or alkoxyl) (by removal of one hydrogen atom from the hydroxyl group of an alkyl alcohol), thiyl (by removal of one hydrogen atom from the thiol group of an alkylthiol), cycloalkyl (by removal of a hydrogen atom from a cycloalkane), cycloheteroalkyl (by removal of a hydrogen atom from a cycloheteroalkane), aryl (by removal of a hydrogen atom from an aromatic ring of the aromatic hydrocarbon), heteroaryl (by removal of a hydrogen atom from any ring atom), amino (by removal of one hydrogel atom from an amine), etc.

The term “divalent radical” refers to an organic radical that is obtained by removing two hydrogen atoms from an organic compound and that forms two bonds with other two groups in an organic compound. For example, an alkylene divalent radical (i.e., alkylenyl) is obtained by removal of two hydrogen atoms from an alkane, a cycloalkylene divalent radical (i.e., cycloalkylenyl) is obtained by removal of two hydrogen atoms from the cyclic ring.

In this application, the term “substituted” in reference to an alkyl or an alkylenyl means that the alkyl or the alkylenyl comprises at least one substituent which replaces one hydrogen atom of the alkyl or the alkylenyl and is selected from the group consisting of hydroxyl (—OH), carboxyl (—COOH), —NH₂, sulfhydryl (—SH), C₁-C₄ alkyl, C₁-C₄ alkoxy, C₁-C₄ alkylthio (alkyl sulfide), C₁-C₄ acylamino, C₁-C₄ alkylamino, di-C₁-C₄ alkylamino, and combinations thereof.

“Post-curing surface treatment”, in reference to a SiHy lens bulk material or a SiHy contact lens, means a surface treatment process that is performed after the SiHy lens bulk material or the SiHy contact lens is formed by curing (i.e., thermally or actinically polymerizing) a SiHy lens formulation.

The term “silicone hydrogel lens formulation” or “SiHy lens formulation” interchangeably refers to a polymerizable composition that comprises all necessary polymerizable components for producing a SiHy contact lens or a SiHy lens bulk material as well known to a person skilled in the art.

A “UV-absorbing vinylic monomer” refers to a compound comprising one sole ethylenically-unsaturated group and can absorb predominantly UV lights between 280 nm to 380 nm. It is understood that a UV-absorbing vinylic monomer does not absorb or absorbs negligibly lights having a wavelength greater 400 nm (i.e., having a % T at 400 nm of greater than 90% when tested with a solution of the UV-absorbing vinylic monomer at a concentration of 0.1 mM and a path length of 1 cm).

A “HEVL-absorbing vinylic monomer” refers to a compound comprising one sole ethylenically-unsaturated group and can absorb HEVL between 380 nm and 450 nm. It is understood that a HEVL-absorbing vinylic monomer can also absorb UV lights between 280 nm and 380 nm.

“UVA” refers to radiation occurring at wavelengths between 315 and 380 nanometers; “UVB” refers to radiation occurring between 280 and 315 nanometers; “HEVL” refers to radiation occurring at wavelengths between 380 and 450 nanometers.

“UVA transmittance” (or “UVA % T”), “UVB transmittance” or “UVB % T”, and “HEVL-transmittance” or “HEVL % T” are calculated by the following formula.

UVA % T=Average % Transmission between 315 nm and 380 nm×100

UVB % T=Average % Transmission between 280 nm and 315 nm×100

HEVL % T=Average % Transmission between 380 nm and 450 nm×100

HEVL % filtration=100%−HEVL % T

“% T at a wavelength” refers to a percent transmission at the specified wavelength.

The “oxygen permeability”, Dkᵢ, of a material is the rate at which oxygen will pass through a material and can be measured at about 34-35° C. according to the procedures described in Example 1. Oxygen permeability is conventionally expressed in units of barrers, where “barrer” is defined as [(cm³ oxygen)(mm)/(cm²)(sec)(mm Hg)]×10⁻¹⁰.

The “oxygen transmissibility”, Dk/t, of a lens or material is the rate at which oxygen will pass through a specific lens or material with an average thickness of t [in units of mm] over the area being measured. Oxygen transmissibility is conventionally expressed in units of barrers/mm, where “barrers/mm” is defined as [(cm³ oxygen)/(cm²)(sec)(mm Hg)]×10⁻⁹.

The term “modulus” or “elastic modulus” in reference to a contact lens or a material means the tensile modulus or Young's modulus which is a measure of the stiffness of a contact lens or a material. The modulus can be measured according to the procedures described in Example 1.

A “coating” in reference to a contact lens means that the contact lens has, on its surfaces, a thin layer of a material that is different from the bulk material of the contact lens and obtained by subjecting the contact lens to a surface treatment.

“Surface modification” or “surface treatment”, as used herein, means that an article has been treated in a surface treatment process, in which (1) a coating is applied to the surface of the article, (2) chemical species are adsorbed onto the surface of the article, (3) the chemical nature (e.g., electrostatic charge) of chemical groups on the surface of the article are altered, or (4) the surface properties of the article are otherwise modified. Exemplary surface treatment processes include, but are not limited to, a surface treatment by energy (e.g., a plasma, a static electrical charge, irradiation, or other energy source), chemical treatments, the grafting of hydrophilic vinylic monomers or macromers onto the surface of an article, mold-transfer coating process disclosed in U.S. Pat. No. 6,719,929, the incorporation of wetting agents into a lens formulation for making contact lenses proposed in U.S. Pat. Nos. 6,367,929 and 6,822,016, reinforced mold-transfer coating disclosed in U.S. Pat. No. 7,858,000, and a hydrophilic coating composed of covalent attachment or physical deposition of one or more layers of one or more hydrophilic polymer onto the surface of a contact lens disclosed in U.S. Pat. Nos. 8,147,897, 8,409,599, 8,557,334, 8,529,057, and 9,505,184.

A “hydrophilic surface” in reference to a SiHy material or a contact lens means that the SiHy material or the contact lens has a surface hydrophilicity characterized by having an averaged water contact angle of about 90 degrees or less, preferably about 80 degrees or less, more preferably about 70 degrees or less, more preferably about 60 degrees or less.

An “average contact angle” refers to a water contact angle (static water contact angle measured by Sessile Drop), which is obtained by averaging measurements of at least 3 individual contact lenses.

In general, the invention is directed to a UV/HEVL-filtering contact lens, more particularly, a UV/HEVL-filtering SiHy contact lens that not only has a relatively high UV/HEVL filtering capability (a UVA % T of less than 5%, UVB % T of 1% or less, a HEVL % T of about 35% or less, a % T at 410 nm of about 15% or less, a % T at 430 nm of about 60% or less, and a % T at 450 nm of about 90% or greater) but also has an aesthetic appealing color (expressed with a*≤−5 and b*≤+18 in CIELAB Color Scale). The present invention is partly based on the discovery that by selecting and combining a UV-absorbing vinylic monomer having an UV-absorption peak at a wavelength of from 280 nm and 380 nm, a first UV/HEVL-absorbing vinylic monomer at a wavelength around 315 nm, a second UV/HEVL-absorbing vinylic monomer at a wavelength around 318 nm, and a blue-tinting polymerizable dye in certain amounts and at a selected ratio into a polymerizable composition for making contact lenses, one can obtain UV/HEVL-filtering contact lenses with a relatively high UV/HEVL filtering capability and an aesthetic appealing color.

The present invention provides a UV/HEVL-filtering contact lens, comprising a bulk silicone hydrogel material that comprises: (1) repeating units of at least one hydrophilic vinylic monomer; (2) repeating units of at least one silicone-containing vinylic monomer and/or at least one polysiloxane vinylic crosslinker; (3) repeating units of at least one UV-absorbing vinylic monomer having an UV absorption peak at a wavelength of from 280 nm and 380 nm; (4) repeating units of a first HEVL-absorbing benzotriazole-containing vinylic monomer having a first HEVL absorption peak at a wavelength of from 410 nm and 420 nm; (5) repeating units of a second HEVL-absorbing benzotriazole-containing vinylic monomer that has a second HEVL absorption peak at a wavelength of from 415 nm and 425 nm, wherein the wavelength of the second HEVL absorption peak is longer than the wavelength of the first HEVL absorption peak; and (6) from about 90 ppm to about 300 ppm of repeating units of at least one polymerizable blue dye (which preferably is 1,4-bis((2-methoxyethyl)amino)-anthraquinone and/or 1,4-bis(4-(2-methacryloxyethyl)phenylamino)-anthraquinone), wherein said components (3), (4) and (5) are present in the bulk silicone hydrogel material in amounts and at a ratio for rendering the UV/HEVL-filtering contact lens to have a UVA % T of less than 5%, UVB % T of about 1% or less, a HEVL % T of about 35% or less (preferably about 32% or less, more preferably about 30% or less, even more preferably about 28% or less), a % T at 410 nm of about 15% or less (preferably about 10% or less), a % T at 430 nm of about 60% or less (preferably about 55% or less), and a % T at 450 nm of about 85% or greater, wherein the UV/HEVL-filtering contact lens has a color expressed with a*≤−5 (preferably a*=−20 to −6) and b*≤+18.

The CIE (Commission Internationale de L'Eclairage) has standardized color order systems. The CIE L*a*b* Color System is used in the invention to express a color by the numbers. The lightness value, L*, also referred to as “Lstar,” defines black at 0 and white at 100.

The a axis is relative to the green-magenta opponent colors, with negative values toward green and positive values toward magenta. The b* axis represents the blue-yellow opponents, with negative numbers toward blue and positive toward yellow. Those values can be determined in color measurements by X-rite, as illustrated in examples.

In accordance with the invention, any hydrophilic vinylic monomers can be used in the invention. Examples of preferred hydrophilic vinylic monomers are alkyl (meth)acrylamides (as described later in this application), hydroxyl-containing acrylic monomers (as described below), amino-containing acrylic monomers (as described later in this application), carboxyl-containing acrylic monomers (as described later in this application), N-vinyl amide monomers (as described later in this application), methylene-containing pyrrolidone monomers (i.e., pyrrolidone derivatives each having a methylene group connected to the pyrrolidone ring at 3- or 5-position) (as described later in this application), acrylic monomers having a C₁-C₄ alkoxyethoxy group (as described later in this application), vinyl ether monomers (as described later in this application), allyl ether monomers (as described later in this application), phosphorylcholine-containing vinylic monomers (as described later in this application), N-2-hydroxyethyl vinyl carbamate, N-carboxyvinyl-β-alanine (VINAL), N-carboxyvinyl-α-alanine, and combinations thereof.

Any siloxane-containing vinylic monomer can be used in the invention. Examples of preferred siloxane-containing vinylic monomers can be siloxane-containing (meth)acrylamido monomers, siloxane-containing (meth)acryloxy monomers, siloxane-containing vinyloxy-carbonyloxy monomers, siloxane-containing vinyloxycarbonylamino monomers, siloxane-containing vinylaminocarbonylamino monomers, or siloxane-containing vinylaminocarbonyloxy monomers, each of which comprises a bis(trialkylsilyloxy)alkylsilyl group, a tris(trialkylsilyloxy)-silyl group, or a polysiloxane chain having 2 to 30 siloxane units and terminated with an alkyl, hydroxyalkyl or methoxyalkyl group. Such preferred siloxane-containing vinylic monomers can be obtained from the commercial suppliers, or alternatively prepared according to known procedures, e.g., similar to those described in U.S. Pat. Nos. 5,070,215, 6,166,236, 6,867,245, 7,214,809, 8,415,405, 8,475,529, 8,614,261, 8,658,748, 9,097,840, 9,103,965, 9,217,813, 9,315,669, and 9,475,827, or by reacting a vinylic monomer having a reactive functional group (e.g., an acid chloride, acid anhydride, carboxyl, hydroxyl, amino, epoxy, isocyanate, aziridine, azlactone, or aldehyde group) with a siloxane-containing compound having a reactive group selected from the group consisting of a hydroxyalkyl, an aminoalkyl, an alkylaminoalkyl, a carboxyalkyl, an isocyanatoalkyl, an epoxyalkyl, and an aziridinylalkyl, in the presence or absence of a coupling agent under coupling reaction conditions well known to a person skilled in the art.

In accordance with the invention, any polysiloxane vinylic crosslinkers can be used in this invention. Examples of preferred polysiloxane vinylic crosslinkers include without limitation α,ω-(meth)acryloxy-terminated polydimethylsiloxanes of various molecular weight; α,ω-(meth)acrylamido-terminated polydimethylsiloxanes of various molecular weight; α,ω-vinyl carbonate-terminated polydimethylsiloxanes of various molecular weight; α,ω-vinyl carbamate-terminated polydimethylsiloxane of various molecular weight; bis-3-methacryloxy-2-hydroxypropyloxypropyl polydimethylsiloxane of various molecular weight; N,N,N′,N′-tetrakis(3-methacryloxy-2-hydroxypropyl)-alpha,omega-bis-3-aminopropyl-polydimethylsiloxane of various molecular weight; the reaction products of glycidyl methacrylate with amino-functional polydimethylsiloxanes; the reaction products of an azlactone-containing vinylic monomer (any one of those described above) with hydroxyl-functional polydimethylsiloxanes; polysiloxane-containing macromer selected from the group consisting of Macromer A, Macromer B, Macromer C, and Macromer D described in U.S. Pat. No. 5,760,100; polysiloxane vinylic crosslinkers disclosed in U.S. Pat. Nos. 4,136,250, 4,153,641, 4,182,822, 4,189,546, 4,259,467, 4,260,725, 4,261,875, 4,343,927, 4,254,248, 4,355,147, 4,276,402, 4,327,203, 4,341,889, 4,486,577, 4,543,398, 4,605,712, 4,661,575, 4,684,538, 4,703,097, 4,833,218, 4,837,289, 4,954,586, 4,954,587, 5,010,141, 5,034,461, 5,070,170, 5,079,319, 5,039,761, 5,346,946, 5,358,995, 5,387,632, 5,416,132, 5,449,729, 5,451,617, 5,486,579, 5,962,548, 5,981,675, 6,039,913, 6,762,264, 7,423,074, 8,163,206, 8,480,227, 8,529,057, 8,835,525, 8,993,651, 9,187,601, 10081697, 10301451, and 10465047.

One class of preferred polysiloxane vinylic crosslinkers are di-(meth)acryloyloxy-terminated polysiloxane vinylic crosslinkers each having dimethylsiloxane units and hydrophilized siloxane units each having one methyl substituent and one monovalent C₄-C₄₀ organic radical substituent having 2 to 6 hydroxyl groups, more preferably a polysiloxane vinylic crosslinker of formula (H), are described later in this application and can be prepared according to the procedures disclosed in U.S. patent Ser. No. 10/081,697.

Another class of preferred polysiloxane vinylic crosslinkers are vinylic crosslinkers each of which comprises one sole polysiloxane segment and two terminal (meth)acryloyl groups, which can be obtained from commercial suppliers; prepared by reacting glycidyl (meth)acrylate (meth)acryloyl chloride with a di-amino-terminated polydimethylsiloxane or a di-hydroxyl-terminated polydimethylsiloxane; prepared by reacting isocyantoethyl (meth)acrylate with di-hydroxyl-terminated polydimethylsiloxanes prepared by reacting an amino-containing acrylic monomer with di-carboxyl-terminated polydimethylsiloxane in the presence of a coupling agent (a carbodiimide); prepared by reacting a carboxyl-containing acrylic monomer with di-amino-terminated polydimethylsiloxane in the presence of a coupling agent (a carbodiimide); or prepared by reacting a hydroxyl-containing acrylic monomer with a dihydroxy-terminated polydisiloxane in the presence of a diisocyanate or diepoxy coupling agent.

Other classes of preferred polysiloxane vinylic crosslinkers are chain-extended polysiloxane vinylic crosslinkers each of which has at least two polysiloxane segments linked by a linker between each pair of polysiloxane segments and two terminal ethylenically unsaturated groups, which can be prepared according to the procedures described in U.S. Pat. Nos. 5,034,461, 5,416,132, 5,449,729, 5,760,100, 7,423,074, 8,529,057, 8,835,525, 8,993,651, 9,187,601, 10301451, and 10465047.

In accordance with the invention, any UV-absorbing vinylic monomers can be used in the invention, so long as they can provide Class I UV protection in combination with UV/HEVL-absorbing vinylic monomer. Preferably, at least one UV-absorbing vinylic monomer can be one or more benzotriazole-containing vinylic monomers (i.e., ones each having a benzotriazole-moiety) selected from the group consisting of 2-(2′-hydroxy-5′-vinylphenyl)-2H-benzotriazole, 2-(2′-hydroxy-5′-methacryloxyphenyl)-2H-benzotriazole, 2-(2′-hydroxy-5′-acryloyloxyphenyl)-2H-benzotriazole, 2-[2′-hydroxy-5′-(2-methacryloxyethyl)phenyl)]-2H-benzotriazole (Norbloc), 2-[2′-hydroxy-5′-(2-acryloxyethyl)phenyl)]-2H-benzotriazole, 2-(2′-hydroxy-5′-methacryloxypropyl-phenyl)-2H-benzotriazole, 2-(2′-hydroxy-5′-acryloxypropylphenyl)-2H-benzotriazole, and combinations thereof. More preferably, at least one UV-absorbing vinylic monomer is 2-[2′-hydroxy-5′-(2-methacryloxyethyl)phenyl)]-2H-benzotriazole (Norbloc).

Benzotriazole-containing UV-absorbing vinyl monomers can be prepared according to procedures described in U.S. Pat. Nos. 3,299,173, 4,612,358, 4,716,234, 4,528,311, 10254567 or can be obtained from commercial suppliers.

In accordance with the invention, any HEVL-absorbing benzotriazole-containing vinylic monomers can be used in the invention, so long as they can meet the specified requirements and provide a desired HEVL-filtering profile. Preferably, the first HEVL-absorbing benzotriazole-containing vinylic monomer is 2-{2′-Hydroxy-3′-tert-butyl-5′-[3′-methacryloyloxypropoxy]phenyl}-5-chloro-2H-benzotriazole (UV28) (having an HEVL absorption peak at 416 nm) whereas the second HEVL-absorbing benzotriazole-containing vinylic monomer is 2-[2′-Hydroxy-3′-tert-butyl-5′-(3′-acryloyloxypropoxy)phenyl]-5-trifluoromethyl-2H-benzotriazole (UV23) (having an HEVL absorption peak at 418 nm).

In accordance with a preferred embodiment of the invention, the bulk silicone hydrogel material (in dried state) of UV/HEVL-filtering contact lens comprises from about 1.2% to about 3.5%, preferably from about 1.5% to about 3.0%, more preferably from about 1.5% to about 2.5% by weight of all components (3), (4) and (5). It is understood that weight percentages of components (3), (4) and (5) in the bulk silicone hydrogel material are determined based on their weight percentages in a polymerizable composition for forming the bulk silicone hydrogel material, relative to total weight of all polymerizable components in the polymerizable composition.

In accordance with the invention, weight ratio of component (4) over component (5) is from about 0.25 to about 2.5 (preferably from about 0.5 to about 2.0). It is understood that weight ratios of components (4) to (5) in the bulk silicone hydrogel material in dried state can be determined based on their weight percentages in a polymerizable composition for forming the bulk silicone hydrogel material, relative to total weight of all polymerizable components in the polymerizable composition.

With such weight ratios in the bulk hydrogel material in dried state, a UV/HEVL-absorbing contact lens may provide Class I UV protection and an enhanced HEVL protection while minimizing their effects on color balance, color vision and tinting color.

Examples of preferred polymerizable blue dyes include without limitation 1,4-bis(4-(2-methacryloxyethyl)phenylamino) anthraquinone (Reactive Blue 246), 1,4-bis((2-methacryloxy-ethyl)amino)anthraquinone (Reactive Blue 247).

In accordance with the invention, a bulk silicone hydrogel material can be formed from a lens formulation (i.e., a polymerizable composition) for forming a silicone hydrogel contact lens.

A contact lens of the invention can be produced in a conventional “spin-casting mold,” as described for example in U.S. Pat. No. 3,408,429, or preferably by the full cast-molding process in a static form, as described in U.S. Pat. Nos. 4,347,198; 5,508,317; 5,583,463; 5,789,464; and 5,849,810, or by lathe cutting of polymeric material buttons as used in making customized contact lenses. In cast-molding, a polymerizable composition (i.e., a lens formulation) typically is dispensed into molds and cured (i.e., polymerized thermally or actinically) in molds for making contact lenses.

A polymerizable composition for forming a bulk silicone hydrogel material of the invention comprises: (1) at least one hydrophilic vinylic monomer (e.g., at least one hydroxyl-containing acrylic monomer, at least one N-vinyl amide monomer, at least one (meth)acrylamido monomer, at least one methylene-containing pyrrolidone monomer, or combinations thereof); (2) at least one siloxane-containing vinylic monomer and/or at least one polysiloxane vinylic crosslinker (e.g., any one of those described in this application); (3) at least one UV-absorbing vinylic monomer having an UV absorption peak at a wavelength of from 280 nm and 380 nm (e.g., Norbloc or any one of those described in this application); (4) a first HEVL-absorbing benzotriazole-containing vinylic monomer having a first HEVL absorption peak at a wavelength of from 410 nm and 420 nm (e.g., UV28); (5) a second HEVL-absorbing benzotriazole-containing vinylic monomer that has a second HEVL absorption peak at a wavelength of from 415 nm and 425 nm (e.g., UV23); (6) from about 100 ppm to about 350 ppm of a polymerizable dye which is reactive blue 247 (1,4-bis((2-methoxyethyl)amino)-anthraquinone), and/or reactive blue 246 (1,4-bis(4-(2-methacryloxyethyl)phenylamino)-anthraquinone); (7) from about 0.2% to about 1.5% by weight of at least one free-radical initiator (e.g., any one of those described in this application); and (8) optionally at least one component selected from the group consisting of at least one hydrophobic non-silicone vinylic monomer (e.g., any one of those described in this application), at least one non-silicone vinylic crosslinker (e.g., any one of those described in this application), a leachable lubricant (e.g., a non-crosslinkable hydrophilic polymer having an average molecular weight from 5,000 to 500,000, preferably from 10,000 to 300,000, more preferably from 20,000 to 100,000 Daltons), a leachable tear-stabilizing agent (e.g., a phospholipid, a monoglyceride, a diglyceride, a triglyceride, a glycolipid, a glyceroglycolipid, a sphingolipid, a sphingo-glycolipid, a fatty acid having 8 to 36 carbon atoms, a fatty alcohol having 8 to 36 carbon atoms, or a mixture thereof), and combinations thereof.

In accordance with the invention, any thermal free-radical initiators can be used in the invention. Suitable thermal free-radical initiators are known to a skilled artisan and include, for example, peroxides, hydroperoxides, azo-bis(alkyl- or cycloalkylnitriles), persulfates, percarbonates, or mixtures thereof. Examples of preferred thermal free-radical initiators include without limitation benzoyl peroxide, t-butyl peroxide, t-amyl peroxybenzoate, 2,2-bis(tert-butylperoxy)butane, 1,1-bis(tert-butylperoxy)cyclohexane, 2,5-Bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, di-t-butyl-diperoxy-phthalate, t-butyl hydroperoxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl)peroxy dicarbonate (Perkadox 16S), di(2-ethylhexyl)peroxy dicarbonate, t-butylperoxy pivalate (Lupersol 11); t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-Azobis[2-(2-imidazolin-2-yl)propane]dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof.

In accordance with the invention, any photoinitiators can be used in the invention so long as it can generate free radicals for initiating polymerization reaction upon being irradiated with a visible light having a wavelength greater 440 nm. Examples of preferred photoinitiators include without limitation benzoylphosphine photoinitiators, acyl germanium photoinitiators (i.e., germanium-based Type I photoinitiators as described in U.S. Pat. No. 7,605,190), acyltin photoinitiators (e.g., tetrakis(2,4,6-trimethylbenzoyl)stannane or others described in U.S. patent application Ser. No. 18/308,210).

Examples of preferred benzoylphosphine initiators include without limitation 2,4,6-trimethylbenzoyldiphenylphosphine oxide (TPO); 2,4,6-trimethylbenzoylethoxy-phenylphosphine oxide (TPO-L); bis(2,4,6-trimethylbenzoyl)phenylphosphine oxide (BAPO); bis-(2,6-dichlorobenzoyl)-4-N-propylphenyl-phosphine oxide; bis-(2,6-dichlorobenzoyl)-4-N-butylphenylphosphine oxide; lithium phenyl(2,4,6-trimethylbenzoyl) phosphinate (LiTPO).

Examples of preferred acyl germanium photoinitiators include without limitation Bis(4-methoxybenzoyl)diethylgermanium (BMBDE-Ge), dibenzoyldiethylgermanium (DBDE-Ge), tetrakis(2-ethylbenzoyl)-germanium (TEB-Ge).

Examples of preferred hydrophobic non-silicone vinylic monomers include without limitation C₁-C₁₀ alkyl (meth)acrylate (e.g., methyl (meth)acrylate, ethyl (meth)acrylate, propyl (meth)acrylate, isopropyl (meth)acrylate, 2-ethylhexyl (meth)acrylate, etc.), cyclohexyl (meth)acrylate, vinyl acetate, vinyl propionate, vinyl butyrate, vinyl valerate, styrene, chloroprene, vinyl chloride, vinylidene chloride, (meth)acrylonitrile, 1-butene, butadiene, vinyl toluene, vinyl ethyl ether, perfluorohexylethyl-thio-carbonyl-aminoethyl-methacrylate, isobornyl (meth)acrylate, trifluoroethyl (meth)acrylate, hexafluoro-isopropyl (meth)acrylate, hexafluorobutyl (meth)acrylate, and combinations thereof.

Examples of preferred non-silicone vinylic crosslinkers include without limitation ethyleneglycol di-(meth)acrylate, diethyleneglycol di-(meth)acrylate, triethyleneglycol di-(meth)acrylate, tetraethyleneglycol di-(meth)acrylate, glycerol di-(meth)acrylate, 1,3-propanediol di-(meth)acrylate, 1,3-butanediol di-(meth)acrylate, 1,4-butanediol di-(meth)acrylate, glycerol 1,3-diglycerolate di-(meth)acrylate, ethylene-bis[oxy(2-hydroxypropane-1,3-diyl)] di-(meth)acrylate, bis[2-(meth)acryloxyethyl] phosphate, trimethylolpropane di-(meth)acrylate, and 3,4-bis[(meth)acryloyl]-tetrahydrofuan, diacrylamide, dimethacrylamide, N,N-di(meth)acryloyl-N-methylamine, N,N-di(meth)acryloyl-N-ethylamine, N,N′-methylene bis(meth)acrylamide, N,N′-ethylene bis(meth)acrylamide, N,N′-dihydroxyethylene bis(meth)acrylamide, N,N′-propylene bis(meth)acrylamide, N,N′-2-hydroxypropylene bis(meth)acrylamide, N,N′-2,3-dihydroxybutylene bis(meth)acrylamide, 1,3-bis(meth)acrylamidepropane-2-yl dihydrogen phosphate, piperazine diacrylamide, tetraethyleneglycol divinyl ether, triethyleneglycol divinyl ether, diethyleneglycol divinyl ether, ethyleneglycol divinyl ether, triallyl isocyanurate, triallyl cyanurate, trimethylopropane trimethacrylate, pentaerythritol tetramethacrylate, bisphenol A dimethacrylate, allylmethacrylate, allylacrylate, N-allyl-methacrylamide, N-allyl-acrylamide, or combinations thereof.

A polymerizable composition of the invention can further comprise antimicrobial agents (e.g., silver nanoparticles), a bioactive agent (e.g., a drug, an amino acid, a polypeptide, a protein, a nucleic acid, 2-pyrrolidone-5-carboxylic acid (PCA), an alpha hydroxyl acid, linoleic and gamma linoleic acids, vitamins, or any combination thereof), or combinations thereof, as known to a person skilled in the art.

In accordance with the invention, a polymerizable composition of the invention is a fluid composition, which can be a solution (i.e., one including non-reactive diluent-solvent), a solventless blend (i.e., a fluid composition free of any non-reactive diluent-solvent).

Where a polymerizable composition of the invention is a solution. It can be prepared by dissolving all of the desirable components in any suitable solvent known to a person skilled in the art. Example of suitable solvents includes without limitation, water, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimetyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl, alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, N-methyl pyrrolidinone, and mixtures thereof. Preferably, a polymerizable composition is a solution of all the desirable components in water, 1,2-propylene glycol, a polyethyleneglycol having a molecular weight of about 400 Daltons or less, or a mixture thereof.

Where a polymerizable composition of the invention is a solventless blend, it can be prepared by mixing all polymerizable components and other necessary component. A solventless polymerizable composition typically comprises at least one blending vinylic monomer as a reactive solvent for dissolving all other polymerizable components of the solventless polymerizable composition. Examples of preferred blending vinylic monomers are described later in this application. Preferably, methyl methacrylate is used as a blending vinylic monomer in preparing a solventless polymerizable composition.

Numerous lens formulations for forming silicone hydrogel contact lenses have been described in numerous patents and patent applications published by the filing date of this application and have been used in producing commercial SiHy contact lenses. Examples of commercial SiHy contact lenses include, without limitation, asmofilcon A, balafilcon A, comfilcon A, delefilcon A, efrofilcon A, enfilcon A, fanfilcon A, galyfilcon A, lotrafilcon A, lotrafilcon B, narafilcon A, narafilcon B, senofilcon A, senofilcon B, senofilcon C, smafilcon A, somofilcon A, and stenfilcon A. They can be used as a base formulation for forming a polymerizable composition for forming a bulk silicone hydrogel material of the invention by adding at least one UV-absorbing vinylic monomer, two HEVL-absorbing vinylic monomers, and at least one polymerizable blue dye in the base formulation.

Lens molds for making contact lenses including SiHy contact lenses are well known to a person skilled in the art and, for example, are employed in cast molding or spin casting. For example, a mold (for cast molding) generally comprises at least two mold sections (or portions) or mold halves, i.e., first and second mold halves. The first mold half defines a first molding (or optical) surface and the second mold half defines a second molding (or optical) surface. The first and second mold halves are configured to receive each other such that a lens-forming cavity is formed between the first molding surface and the second molding surface. The molding surface of a mold half is the cavity-forming surface of the mold and in direct contact with the polymerizable composition.

The mold halves can be formed through various techniques, such as injection molding. Methods of manufacturing mold halves for cast-molding a contact lens are generally well known to those of ordinary skill in the art. The process of the present invention is not limited to any particular method of forming a mold. In fact, any method of forming a mold can be used in the present invention. The mold halves can be formed through various techniques, such as injection molding or lathing. Examples of suitable processes for forming the mold halves are disclosed in U.S. Pat. Nos. 4,444,711; 4,460,534; 5,843,446; and 5,894,002.

Virtually all materials known in the art for making molds can be used to make molds for making contact lenses. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used. Other materials that allow UV light transmission could be used, such as quartz glass and sapphire.

In accordance with the invention, a polymerizable composition can be introduced (dispensed) into a cavity formed by a mold according to any known methods.

After the polymerizable composition is dispensed into the mold, it is polymerized to produce a contact lens. Crosslinking may be initiated thermally or actinically to crosslink the polymerizable components in the polymerizable composition.

The thermal polymerization is carried out conveniently, for example at a temperature of from 25 to 120° C. and preferably 40 to 100° C. The reaction time may vary within wide limits, but is conveniently, for example, from 30 minutes to 4 hours or preferably from 1 to 2 hours. It is advantageous to previously degas the components and solvents used in the polymerization reaction and to carry out said copolymerization reaction under an inert atmosphere, for example under a nitrogen or argon atmosphere.

The actinic polymerization can then be triggered off by actinic radiation, for example, a visible light of a suitable wavelength.

After the curing step, the steps of opening a mold (i.e., separating the male mold half from the female mold half with the contact lens attached onto one of the male and female mold halves and delensing (i.e., removing the contact lens from the lens adhered mold half) are carried out according to any techniques known to a person skilled in the art.

After the molded contact lens is delensed, it typically is extracted with an extraction medium as well known to a person skilled in the art. The extraction liquid medium is any solvent capable of dissolving the diluent(s), unpolymerized polymerizable materials, and oligomers in the lens precursor. Water, any organic solvents described above or known to a person skilled in the art, or a mixture thereof can be used in the invention.

The extracted contact lens can then be hydrated according to any method known to a person skilled in the art.

The extracted and/or hydrated contact lens can further subject to further processes, such as, for example, surface treatment, packaging in lens packages with a packaging solution which is well known to a person skilled in the art; sterilization such as autoclave at from 118 to 124° C. for at least about 30 minutes; and the like.

Lens packages (or containers) are well known to a person skilled in the art for autoclaving and storing a soft contact lens. Any lens packages can be used in the invention.

Preferably, a lens package is a blister package which comprises a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes under pressure) prior to dispensing to users. A person skilled in the art will understand well how to seal and sterilize lens packages.

A contact lens of the invention has an oxygen permeability of preferably at least about 40 barrers, more preferably at least about 60 barrers, even more preferably at least about 80 barrers (at about 35° C.).

A contact lens of the invention has an elastic modulus of about 1.5 MPa or less, preferably about 1.2 MPa or less, more preferably from about 0.3 MPa to about 1.0 MPa (at a temperature of from about 22° C. to 28° C.).

A contact lens of the invention further has an equilibrium water content of from about 15% to about 75%, more preferably from about 20% to about 70% by weight, even more preferably from about 25% to about 65% by weight (at room temperature) when fully hydrated. The equilibrium water content of a photochromic SiHy contact lens can be measured according to the procedure disclosed in Example 1.

In other aspects, the invention provides method for making UV/HEVL-filtering silicone hydrogel contact lenses, comprising the steps of: introducing a polymerizable composition into a mold, wherein the polymerizable composition comprises (1) at least one hydrophilic vinylic monomer; (2) at least one siloxane-containing vinylic monomer and/or at least one polysiloxane vinylic crosslinker; (3) at least one UV-absorbing vinylic monomer having an UV absorption peak at a wavelength of from 280 nm and 380 nm; (4) a first HEVL-absorbing benzotriazole-containing vinylic monomer having a first HEVL absorption peak at a wavelength of from 410 nm and 420 nm; (5) a second HEVL-absorbing benzotriazole-containing vinylic monomer that has a second HEVL absorption peak at a wavelength of from 415 nm and 425 nm; (6) from about 100 ppm to about 350 ppm of a polymerizable blue dye; (7) from about 0.2% to about 1.5% by weight of at least one free-radical initiator; and (8) optionally at least one component selected from the group consisting of at least one hydrophobic non-silicone vinylic monomer, at least one non-silicone vinylic crosslinker, a leachable lubricant, a leachable tear-stabilizing agent, and combinations thereof, wherein the mold comprises a female mold halve having a first molding surface and a male mold half having a second molding surface, wherein the mold halves are configured to receive each other such that a lens-forming cavity is formed between the first molding surface and the second molding surface; curing the polymerizable composition in the mold to form a UV/HEVL-filtering silicone hydrogel contact lens precursor; removing the UV/HEVL-filtering silicone hydrogel contact lens precursor from the mold; and subjecting the UV/HEVL-filtering silicone hydrogel contact lens precursor to one or more post-molding processes selected from the group consisting of extraction, hydration, surface treatment, packaging, sterilization, and combinations thereof.

All of the various embodiments of polymerizable compositions, hydrophilic vinylic monomers, silicone-containing vinylic monomers, polysiloxane vinylic crosslinkers, UV-absorbing vinylic monomers, HEVL-absorbing benzotriazole-containing vinylic monomers, poymerizable blue dyes, non-silicone hydrophobic vinylic monomers, non-silicone vinylic crosslinkers, free-radical initiators, leachable lubricants, leachable tear-stabilizing agents, antimicrobial agents, bioactive agents, non-reactive-diluents (solvents), molds, thermal curing, photocuring, demolding, delensing, extraction, hydration, surface treatment, packaging, and autoclaving have been described above and can be used in these aspects of the invention.

Although various embodiments of the invention have been described using specific terms, devices, and methods, such description is for illustrative purposes only. The words used are words of description rather than of limitation. It is to be understood that changes and variations may be made by those skilled in the art without departing from the spirit or scope of the present invention, which is set forth in the following claims. In addition, it should be understood that aspects of the various embodiments may be interchanged either in whole or in part or can be combined in any manner and/or used together, as illustrated below:

1.

A UV/HEVL-filtering silicone hydrogel contact lens, comprising a bulk silicone hydrogel material that comprises:
(1) repeating units of at least one hydrophilic vinylic monomer;
(2) repeating units of at least one silicone-containing vinylic monomer and/or at least one polysiloxane vinylic crosslinker;
(3) repeating units of at least one UV-absorbing vinylic monomer having an UV absorption peak at a wavelength of from 280 nm and 380 nm;
(4) repeating units of a first HEVL-absorbing benzotriazole-containing vinylic monomer having a first HEVL absorption peak at a wavelength of from 410 nm and 425 nm;
(5) repeating units of a second HEVL-absorbing benzotriazole-containing vinylic monomer that has a second HEVL absorption peak at a wavelength of from 410 nm and 425 nm, wherein the wavelength of the second HEVL absorption peak is longer than the wavelength of the first HEVL absorption peak; and
(6) from about 90 ppm to about 300 ppm of repeating units of at least one polymerizable blue dye,
wherein said components (3), (4) and (5) are present in the bulk silicone hydrogel material in amounts and at a ratio for rendering the UV/HEVL-filtering contact lens to have a UVA % T of less than 5%, UVB % T of about 1% or less, a HEVL % T of about 35% or less, a % T at 410 nm of about 15% or less, a % T at 430 nm of about 60% or less, and a % T at 450 nm of about 85% or greater, wherein the UV/HEVL-filtering contact lens has a color expressed with a*≤−5 and b*≤+18.

2. The UV/HEVL-filtering silicone hydrogel contact lens of embodiment 1, wherein the UV/HEVL-filtering contact lens has a HEVL % T of about 32% or less.

3. The UV/HEVL-filtering silicone hydrogel contact lens of embodiment 1, wherein the UV/HEVL-filtering contact lens has a HEVL % T of about 30% or less.

4. The UV/HEVL-filtering silicone hydrogel contact lens of embodiment 1, wherein the UV/HEVL-filtering silicone hydrogel contact lens has a HEVL % T of about 28% or less.

5. The UV/HEVL-filtering silicone hydrogel contact lens of any one of embodiments 1 to 4, wherein the UV/HEVL-filtering silicone hydrogel contact lens has a % T at 410 nm of about 10% or less.

6. The UV/HEVL-filtering silicone hydrogel contact lens of any one of embodiments 1 to 5, wherein the UV/HEVL-filtering silicone hydrogel contact lens has a % T at 430 nm of about 55% or less.

7. The UV/HEVL-filtering silicone hydrogel contact lens of any one of embodiments 1 to 6, wherein the UV/HEVL-filtering silicone hydrogel contact lens has a color expressed with a*=−20 to −6 and b*≤+18.

8. The UV/HEVL-filtering silicone hydrogel contact lens of any one of embodiments 1 to 7, wherein said at least one polymerizable blue dye is 1,4-bis((2-methoxyethyl)amino)-anthraquinone and/or 1,4-bis(4-(2-methacryloxyethyl)phenylamino)-anthraquinone.

9. The UV/HEVL-filtering silicone hydrogel contact lens of any one of embodiments 1 to 8, wherein said at least one UV-absorbing vinylic monomer comprises a benzotriazole-containing vinylic monomer.

10. The UV/HEVL-filtering silicone hydrogel contact lens of embodiment 9, wherein said at least one UV-absorbing vinylic monomer comprises 2-(2′-hydroxy-5′-vinylphenyl)-2H-benzotriazole, 2-(2′-hydroxy-5′-methacryloxyphenyl)-2H-benzotriazole, 2-(2′-hydroxy-5′-acryloyloxyphenyl)-2H-benzotriazole, 2-[2′-hydroxy-5′-(2-methacryloxyethyl)phenyl)]-2H-benzotriazole (Norbloc), 2-[2′-hydroxy-5′-(2-acryloxyethyl)phenyl)]-2H-benzotriazole, 2-(2′-hydroxy-5′-methacryloxypropyl-phenyl)-2H-benzotriazole, 2-(2′-hydroxy-5′-acryloxypropylphenyl)-2H-benzotriazole, or combinations thereof.

11. The UV/HEVL-filtering silicone hydrogel contact lens of embodiment 9, wherein said at least one UV-absorbing vinylic monomer is 2-[2′-hydroxy-5′-(2-methacryloxyethyl)phenyl)]-2H-benzotriazole.

12. The UV/HEVL-filtering silicone hydrogel contact lens of any one of embodiments 1 to 11, wherein the first HEVL-absorbing benzotriazole-containing vinylic monomer is 2-{2′-Hydroxy-3′-tert-butyl-5′-[3′-methacryloyloxypropoxy]phenyl}-5-chloro-2H-benzotriazole (UV28).

13. The UV/HEVL-filtering silicone hydrogel contact lens of any one of embodiments 1 to 12, wherein the second HEVL-absorbing benzotriazole-containing vinylic monomer is 2-[2′-Hydroxy-3′-tert-butyl-5′-(3′-acryloyloxypropoxy)phenyl]-5-trifluoromethyl-2H-benzotriazole (UV23).

14. The UV/HEVL-filtering silicone hydrogel contact lens of any one of embodiments 1 to 13, wherein the bulk silicone hydrogel material in dried state comprises from about 1.2% to about 3.5% by weight of all components (3), (4) and (5).

15. The UV/HEVL-filtering silicone hydrogel contact lens of any one of embodiments 1 to 13, wherein the bulk silicone hydrogel material in dried state comprises from about 1.5% to about 3.0% by weight of all components (3), (4) and (5).

16. The UV/HEVL-filtering silicone hydrogel contact lens of any one of embodiments 1 to 14, wherein the bulk silicone hydrogel material in dried state comprises from about 1.5% to about 2.5% by weight of all components (3), (4) and (5).

17. The UV/HEVL-filtering silicone hydrogel contact lens of any one of embodiments 1 to 16, wherein weight ratio of component (4) over component (5) is from about 0.25 to about 2.5.

18. The UV/HEVL-filtering silicone hydrogel contact lens of any one of embodiments 1 to 16, wherein weight ratio of component (4) over component (5) is from about 0.5 to about 2.0.

19. The UV/HEVL-filtering silicone hydrogel contact lens of any one of embodiments 1 to 18, wherein said at least one hydrophilic vinylic monomer comprises: (1) an alkyl (meth)acrylamide selected from the group consisting of (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, and combinations thereof; (2) a hydroxyl-containing acrylic monomer selected from the group consisting of N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, and combinations thereof; (3) a carboxyl-containing acrylic monomer selected from the group consisting of 2-(meth)acrylamidoglycolic acid, (meth)acrylic acid, ethylacrylic acid, 3-(meth)acrylamidopropionic acid, 5-(meth)acrylamidopentanoic acid, 4-(meth)acrylamidobutanoic acid, 3-(meth)acrylamido-2-methylbutanoic acid, 3-(meth)acrylamido-3-methylbutanoic acid, 2-(meth)acrylamido-2methyl-3,3-dimethyl butanoic acid, 3-(meth)acrylamidohaxanoic acid, 4-(meth)acrylamido-3,3-dimethylhexanoic acid, and combinations thereof; (4) an amino-containing acrylic monomer selected from the group consisting of N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-3-aminopropyl (meth)acrylamide, N-3-methylaminopropyl (meth)acrylamide, N-3-dimethylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-ethylaminopropyl (meth)acrylate, 3-amino-2-hydroxypropyl (meth)acrylate, trimethylammonium 2-hydroxy propyl (meth)acrylate hydrochloride, dimethylaminoethyl (meth)acrylate, and combinations thereof; (5) an N-vinyl amide monomer selected from the group consisting of N-vinylpyrrolidone (aka, N-vinyl-2-pyrrolidone), N-vinyl-3-methyl-2-pyrrolidone, N-vinyl-4-methyl-2-pyrrolidone, N-vinyl-5-methyl-2-pyrrolidone, N-vinyl-6-methyl-2-pyrrolidone, N-vinyl-3-ethyl-2-pyrrolidone, N-vinyl-4,5-dimethyl-2-pyrrolidone, N-vinyl-5,5-dimethyl-2-pyrrolidone, N-vinyl-3,3,5-trimethyl-2-pyrrolidone, N-vinyl piperidone (aka, N-vinyl-2-piperidone), N-vinyl-3-methyl-2-piperidone, N-vinyl-4-methyl-2-piperidone, N-vinyl-5-methyl-2-piperidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl caprolactam (aka, N-vinyl-2-caprolactam), N-vinyl-3-methyl-2-caprolactam, N-vinyl-4-methyl-2-caprolactam, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinyl-N-methyl acetamide, N-vinyl formamide, N-vinyl acetamide, N-vinyl isopropylamide, N-vinyl-N-ethyl acetamide, N-vinyl-N-ethyl formamide, and mixtures thereof; (6) a methylene-containing pyrrolidone monomer selected from the group consisting of 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, and combinations thereof; (7) an acrylic monomer having a C₁-C₄ alkoxyethoxy group and selected from the group consisting of ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a number average molecular weight of up to 1500, methoxy-poly(ethylene glycol)ethyl (meth)acrylamide having a number average molecular weight of up to 1500, and combinations thereof; (8) a vinyl ether monomer selected from the group consisting of ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol) methyl vinyl ether, tri(ethylene glycol) methyl vinyl ether, tetra(ethylene glycol) methyl vinyl ether, poly(ethylene glycol) methyl vinyl ether, and combinations thereof; (9) an allyl ether monomer selected from the group consisting of ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol) methyl allyl ether, tri(ethylene glycol) methyl allyl ether, tetra(ethylene glycol) methyl allyl ether, poly(ethylene glycol) methyl allyl ether, and combinations thereof; (10) a phosphorylcholine-containing vinylic monomer selected from the group consisting of (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)-ethylphosphate, 3-[(meth)acryloylamino]propyl-2′-(trimethylammonio)ethylphosphate, 4-[(meth)acryloylarnino]butyl-2′-(trimethylammonio)ethylphosphate, 5-((meth)acryloyloxy)pentyl-2′-(trimethylammonio)ethyl phosphate, 6-((meth)acryloyloxy)hexyl-2′-(trimethylammonio)-ethylphosphate, 2-(meth)acryloyloxy)ethyl-2′-(triethylammonio)ethylphosphate, 2-((meth)acryloyloxy)ethyl-2′-(tripropylammonium)ethylphosphate, 2-((meth)acryloyloxy)ethyl-2′-(tributyl ammonio)ethyl phosphate, 2-((meth)acryloyloxy)propyl-2′-(trimethylammonio)-ethylphosphate, 2-((meth)acryloyloxy)butyl-2′-(trimethylammonio)ethylphosphate, 2-((meth)acryloyloxy)pentyl-2′-(trimethylammonio)ethylphosphate, 2-((meth)acryloyloxy)hexyl-2′-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(triethylammonio)ethyl phosphate, 2-(allyloxycarbonyl)ethyl-2′-(trimethyl ammonio)-ethylphosphate, 2-(vinylcarbonylamino)ethyl-2′-(trimethylammonio)ethylphosphate, 2-(allyloxycarbonylamino)ethyl-2′-(trimethylammonio)ethyl phosphate, 2-(butenoyloxy)ethyl-2′-(trimethylammonio)ethylphosphate, and combinations thereof; (11) allyl alcohol; (12) N-2-hydroxyethyl vinyl carbamate; (13) N-carboxyvinyl-β-alanine (VINAL); (14) N-carboxyvinyl-α-alanine; (15) or combinations thereof.

20. The UV/HEVL-filtering silicone hydrogel contact lens of any one of embodiments 1 to 19, wherein the bulk silicone hydrogel material comprises repeating units of at least one siloxane-containing vinylic monomer.

21. The UV/HEVL-filtering silicone hydrogel contact lens of embodiment 20, wherein said at least one siloxane-containing vinylic monomer is selected from the group consisting of α-(meth)acryloxypropyl terminated w-C₁-C₄-alkyl terminated polydimethylsiloxane, α-(meth)acryloxy-2-hydroxypropyloxypropyl terminated w-C₁-C₄-alkyl terminated polydimethylsiloxane, α-(2-hydroxyl-methacryloxypropyloxypropyl)-ω-C₁-C₄-alkyl-decamethylpentasiloxane, α-[3-(meth)acryloxyethoxy-2-hydroxypropyloxypropyl]-terminated w-C₁-C₄-alkyl terminated polydimethylsiloxane, α-[3-(meth)acryloxy-propyloxy-2-hydroxypropyloxypropyl]-terminated ω-C₁-C₄-alkyl terminated polydimethylsiloxane, α-[3-(meth)acryloxyisopropyloxy-2-hydroxypropyloxypropyl]-terminated ω-C₁-C₄-alkyl terminated polydimethylsiloxane, α-[3-(meth)acryloxybutyloxy-2-hydroxypropyloxypropyl]-terminated ω-C₁-C₄-alkyl terminated polydimethylsiloxane, α-[3-(meth)acryloxyethylamino-2-hydroxypropyloxypropyl]-terminated ω-C₁-C₄-alkyl terminated polydimethylsiloxane, α-[3-(meth)acryloxypropylamino-2-hydroxypropyloxypropyl]-terminated ω-C₁-C₄-alkyl terminated polydimethylsiloxane, α-[3-(meth)acryloxy-butylamino-2-hydroxypropyloxypropyl]-terminated ω-C₁-C₄-alkyl terminated polydimethylsiloxane, α-(meth)acryloxy(polyethylenoxy)-2-hydroxypropyloxypropyl]-terminated ω-C₁-C₄-alkyl terminated polydimethylsiloxane, α-[(meth)acryloxy-2-hydroxypropyloxy-ethoxypropyl]-terminated ω-C₁-C₄-alkyl terminated polydimethylsiloxane, α-[(meth)acryloxy-2-hydroxypropyl-N-ethylaminopropyl]-terminated ω-C₁-C₄-alkyl terminated polydimethylsiloxane, α-[(meth)acryloxy-2-hydroxypropyl-aminopropyl]-terminated ω-C₁-C₄-alkyl terminated polydimethylsiloxane, α-[(meth)acryloxy-2-hydroxypropyloxy-(polyethylenoxy)propyl]-terminated ω-C₁-C₄-alkyl terminated polydimethylsiloxane, α-(meth)acryloylamidopropyloxypropyl terminated ω-C₁-C₄-alkyl terminated polydimethylsiloxane, α-N-methyl-(meth)acryloylamidopropyloxypropyl terminated ω-C₁-C₄-alkyl terminated polydimethylsiloxane, α-[3-(meth)acrylamidoethoxy-2-hydroxypropyloxy-propyl]-terminated ω-C₁-C₄-alkyl polydimethylsiloxane, α-[3-(meth)acrylamidopropyloxy-2-hydroxypropyloxypropyl]-terminated ω-C₁-C₄-alkyl terminated polydimethylsiloxane, α-[3-(meth)acrylamidoisopropyloxy-2-hydroxypropyloxypropyl]-terminated ω-C₁-C₄-alkyl terminated polydimethylsiloxane, α-[3-(meth)acrylamidobutyloxy-2-hydroxypropyloxypropyl]-terminated ω-C₁-C₄-alkyl terminated polydimethylsiloxane, α-[3-(meth)acryloylamido-2-hydroxypropyloxypropyl] terminated ω-C₁-C₄-alkyl polydimethylsiloxane, α-[3-[N-methyl-(meth)acryloylamido]-2-hydroxypropyloxypropyl] terminated ω-C₁-C₄-alkyl terminated polydimethylsiloxane, N-methyl-N′-(propyltetra(dimethylsiloxy)dimethylbutylsilane) (meth)acrylamide, N-(2,3-dihydroxypropane)-N′-(propyltetra(dimethylsiloxy)dimethylbutylsilane) (meth)acrylamide, (meth)acryloylamidopropyltetra(dimethylsiloxy)dimethylbutylsilane, α-vinyl carbonate-terminated ω-C₁-C₄-alkyl-terminated polydimethylsiloxanes, α-vinyl carbamate-terminated ω-C₁-C₄-alkyl-terminated polydimethylsiloxane, and a mixture thereof.

22. The UV/HEVL-filtering silicone hydrogel contact lens of embodiment 20, wherein said at least one siloxane-containing vinylic monomer is selected from the group consisting of a vinylic monomer having a bis(trialkylsilyloxy)alkylsilyl group, a vinylic monomer having a tris(trialkylsilyloxy)silyl group, a polysiloxane vinylic monomer, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, and combinations thereof.

23. The UV/HEVL-filtering silicone hydrogel contact lens of embodiment 20, wherein said at least one siloxane-containing vinylic monomer comprises at least one vinylic monomer of formula (M1) or (M2)

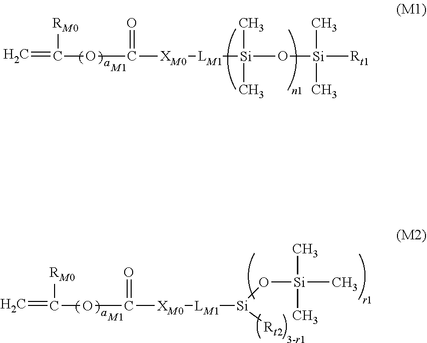

in which: a_{M1} is zero or 1; R_{M0} is H or methyl; X_{M0} is O or NR_{M1}; L_{M1} is a C₂-C₈ alkylene divalent

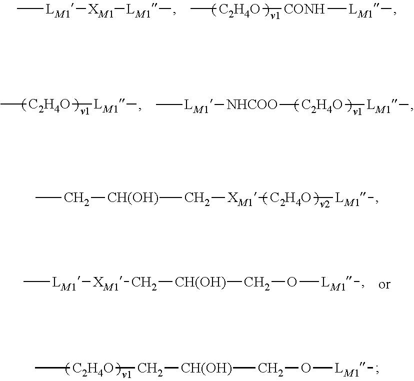

L_{M1}′ is a C₂-C₈ alkylene divalent radical which has zero or one hydroxyl group; L_{M1}″ is C₃-C₈ alkylene divalent radical which has zero or one hydroxyl group; X_{M1} is O, NR_{M1}, NHCOO, OCONH, CONR_{M1}, or NR_{M1}CO; R_{M1} is H or a C₁-C₄ alkyl having 0 to 2 hydroxyl group; Rₜ₁ and Rₜ₂ independent of each other are a C₁-C₆ alkyl; X_{M1}′ is O or NR_{M1}; v1 is an integer of 1 to 30; m2 is an integer of 0 to 30; n1 is an integer of 3 to 40; and r1 is an integer of 2 or 3.

24. The UV/HEVL-filtering silicone hydrogel contact lens of embodiment 20, wherein said at least one siloxane-containing vinylic monomer comprises tris(trimethylsilyloxy)silylpropyl (meth)acrylate, [3-(meth)acryloxy-2-hydroxypropyloxy]propylbis(trimethylsiloxy)-methylsilane, [3-(meth)acryloxy-2-hydroxypropyloxy]propylbis(trimethylsiloxy)butylsilane, 3-(meth)acryloxy-2-(2-hydroxyethoxy)-propyloxy)propylbis(trimethylsiloxy)methylsilane, 3-(meth)acryloxy-2-hydroxypropyloxy)propyltris(trimethylsiloxy)silane, N-[tris(trimethylsiloxy)-silylpropyl]-(meth)acrylamide, N-(2-hydroxy-3-(3-(bis(trimethylsilyloxy)methylsilyl)-propyloxy)propyl)-2-methyl (meth)acrylamide, N-(2-hydroxy-3-(3-(bis(trimethylsilyloxy)-methylsilyl)propyloxy)-propyl) (meth)acrylamide, N-(2-hydroxy-3-(3-(tris(trimethylsilyloxy)-silyl)propyloxy)propyl)-2-methyl acrylamide, N-(2-hydroxy-3-(3-(tris(trimethylsilyloxy)silyl)-propyloxy)propyl) (meth)acrylamide, N-[tris(dimethylpropylsiloxy)silylpropyl]-(meth)acrylamide, N-[tris(dimethylphenylsiloxy)-silylpropyl] (meth)acrylamide, N-[tris(dimethylethylsiloxy)-silylpropyl] (meth)acrylamide, N,N-bis[2-hydroxy-3-(3-(bis(trimethylsilyloxy)methylsilyl)-propyloxy)propyl]-2-methyl (meth)acrylamide, N,N-bis[2-hydroxy-3-(3-(bis(trimethylsilyloxy)methylsilyl)propyloxy)-propyl](meth)acrylamide, N,N-bis[2-hydroxy-3-(3-(tris(trimethylsilyloxy)silyl)propyloxy)-propyl]-2-methyl (meth)acrylamide, N,N-bis[2-hydroxy-3-(3-(tris(trimethylsilyloxy)silyl)-propyloxy)propyl](meth)acrylamide, N-[2-hydroxy-3-(3-(t-butyldimethylsilyl)propyloxy)-propyl]-2-methyl (meth)acrylamide, N-[2-hydroxy-3-(3-(t-butyldimethylsilyl)propyloxy)-propyl] (meth)acrylamide, N,N-bis[2-hydroxy-3-(3-(t-butyldimethylsilyl)propyloxy)propyl]-2-methyl (meth)acrylamide, N-2-(meth)acryloxyethyl-O-(methyl-bis-trimethylsiloxy-3-propyl)silyl carbamate, 3-(trimethylsilyl)propylvinyl carbonate, 3-(vinyloxycarbonylthio)-propyl-tris(trimethyl-siloxy)silane, 3-[tris(trimethylsiloxy)silyl]propylvinyl carbamate, 3-[tris(trimethylsiloxy)silyl] propyl allyl carbamate, 3-[tris(trimethylsiloxy)silyl]propyl vinyl carbonate, or a combination thereof.

25. The UV/HEVL-filtering silicone hydrogel contact lens of any one of embodiments 1 to 24, wherein the bulk silicone hydrogel material comprises repeating units of said at least one polysiloxane vinylic crosslinker.

26. The UV/HEVL-filtering silicone hydrogel contact lens of embodiment 25, wherein said at least one polysiloxane vinylic crosslinker comprises a di-(meth)acryloyloxy-terminated polysiloxane vinylic crosslinker having dimethylsiloxane units and hydrophilized siloxane units each having one methyl substituent and one monovalent C₄-C₄₀ organic radical substituent having 2 to 6 hydroxyl groups.

27. The UV/HEVL-filtering silicone hydrogel contact lens of embodiment 25, wherein said at least one polysiloxane vinylic crosslinker comprises at least one hydrophilized polysiloxane vinylic crosslinker of formula (G)

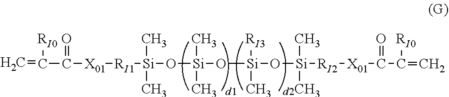

in which:
   d1 is an integer of from 30 to 500 and d2 is an integer of from 1 to 75, provided that d2/d1 is from about 0.035 to about 0.15;
   X₀₁ is O or NR_{IN} in which R_{IN} is hydrogen or C₁-C₁₀-alkyl;
   R_{I0} is hydrogen or methyl;
   R_{I1} and R_{I2} independently of each other are a substituted or unsubstituted C₁-C₁₀ alkylene divalent radical or a divalent radical of —R_{I4}—O—R_{I5}— in which R_{I4} and R_{I5} independently of each other are a substituted or unsubstituted C₁-C₁₀ alkylene divalent radical;
   R_{I3} is a monovalent radical of any one of formula (G-1) to (G-5)

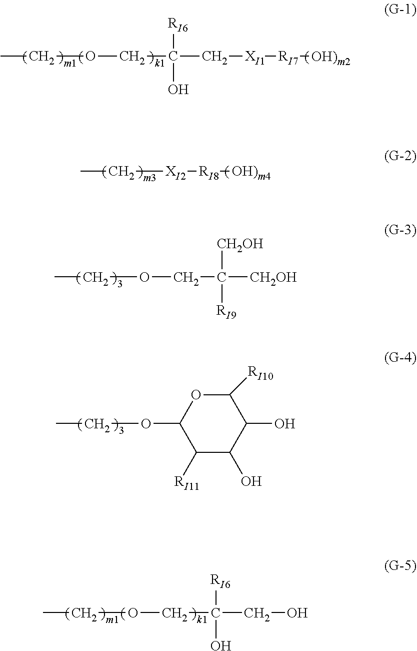

k1 is zero or 1; m1 is an integer of 2 to 4; m2 is an integer of 1 to 5; m3 is an integer of 3 to 6;
m4 is an integer of 2 to 5;
R_{I6} is hydrogen or methyl;
R_{I7} is a C₂-C₆ hydrocarbon radical having (m2+1) valencies;
R_{I8} is a C₂-C₆ hydrocarbon radical having (m4+1) valencies;
R_{I9} is ethyl or hydroxymethyl;
R_{I10} is methyl or hydromethyl;
R_{I11} is hydroxyl or methoxy;
X_{I1} is a sulfur linkage of —S— or a teriary amino linkage of —NR_{I12}— in which R_{I12} is C₁-C₁ alkyl, hydroxyethyl, hydroxypropyl, or 2,3-dihydroxypropyl; and
X₁₂ is an amide linkage of

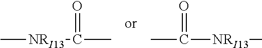

in which R_{I13} is hydrogen or C₁-C₁₀ alkyl.

28. The UV/HEVL-filtering silicone hydrogel contact lens of embodiment 25, wherein said at least one polysiloxane vinylic crosslinker comprises: (i) a vinylic crosslinker which comprises one sole polydiorganosiloxane segment and two terminal ethylenically-unsaturated groups selected from the group consisting of (meth)acryloyloxy groups, (meth)acryloylamino groups, vinyl carbonate groups, vinylcarbamate groups; and/or (ii) a chain-extended polysiloxane vinylic crosslinker which comprises at least two polydiorganosiloxane segment and a covalent linker between each pair of polydiorganosiloxane segments and two two terminal ethylenically-unsaturated groups selected from the group consisting of (meth)acryloyloxy groups, (meth)acryloylamino groups, vinyl carbonate groups, vinylcarbamate groups.

29. The UV/HEVL-filtering silicone hydrogel contact lens of embodiment 25, wherein said at least one polysiloxane vinylic crosslinker comprises α,ω-bis[3-(meth)acrylamidopropyl]-terminated polydimethylsiloxane, α,ω-bis[3-(meth)acryloxypropyl]-terminated polydimethylsiloxane, α,ω-bis[3-(meth)acryloxy-2-hydroxypropyloxypropyl]-terminated polydimethylsiloxane, α,ω-bis[3-(meth)acryloxyethoxy-2-hydroxypropyloxypropyl]-terminated polydimethylsiloxane, α,ω-bis[3-(meth)acryloxypropyloxy-2-hydroxypropyloxypropyl]-terminated polydimethylsiloxane, α,ω-bis[3-(meth)acryloxy-isopropyloxy-2-hydroxypropyloxypropyl]-terminated polydimethylsiloxane, α,ω-bis[3-(meth)acryloxybutyloxy-2-hydroxypropyloxypropyl]-terminated polydimethylsiloxane, α,ω-bis[3-(meth)acrylamidoethoxy-2-hydroxypropyloxypropyl]-terminated polydimethylsiloxane, α,ω-bis[3-(meth)acrylamidopropyloxy-2-hydroxypropyloxypropyl]-terminated polydimethylsiloxane, α,ω-bis[3-(meth)acrylamidoisopropyloxy-2-hydroxypropyloxypropyl]-terminated polydimethylsiloxane, α,ω-bis[3-(meth)acrylamidobutyloxy-2-hydroxypropyloxypropyl]-terminated polydimethylsiloxane, α,ω-bis[3-(meth)acryloxyethylamino-2-hydroxypropyloxypropyl]-terminated polydimethylsiloxane, α,ω-bis[3-(meth)acryloxypropylamino-2-hydroxypropyloxypropyl]-terminated polydimethylsiloxane, α,ω-bis[3-(meth)acryloxybutylamino-2-hydroxypropyloxypropyl]-terminated polydimethylsiloxane, α,ω-bis[(meth)acrylamidoethylamino-2-hydroxypropyloxy-propyl]-terminated polydimethylsiloxane, α,ω-bis[3-(meth)acrylamidopropylamino-2-hydroxypropyloxypropyl]-terminated polydimethylsiloxane, α,ω-bis[3-(meth)acrylamide-butylamino-2-hydroxypropyloxypropyl]-terminated polydimethylsiloxane, α,ω-bis[(meth)acryloxy-2-hydroxypropyloxy-ethoxypropyl]-terminated polydimethylsiloxane, α,ω-bis[(meth)acryloxy-2-hydroxypropyl-N-ethylaminopropyl]-terminated polydimethylsiloxane, α,ω-bis[(meth)acryloxy-2-hydroxypropyl-aminopropyl]-polydimethylsiloxane, α,ω-bis[(meth)acryloxy-2-hydroxypropyloxy-(polyethylenoxy)propyl]-terminated polydimethylsiloxane, α,ω-bis[(meth)acryloxyethylamino-carbonyloxy-ethoxypropyl]-terminated polydimethylsiloxane, α,ω-bis[(meth)acryloxyethylamino-carbonyloxy-(polyethylenoxy)propyl]-terminated polydimethylsiloxane, or combinations thereof.

30. The UV/HEVL-filtering silicone hydrogel contact lens of any one of embodiments 1 to 29, wherein said at least one hydrophilic vinylic monomer comprises at least one hydrophilic N-vinyl amide monomer selected from the group consisting of N-vinylpyrrolidone, N-vinyl piperidone, N-vinyl caprolactam, N-vinyl-N-methyl acetamide, N-vinyl formamide, N-vinyl acetamide, N-vinyl isopropylamide, N-vinyl-N-methyl acetamide, N-vinyl-N-ethyl acetamide, N-vinyl-N-ethyl formamide, and mixtures thereof.

31. The UV/HEVL-filtering silicone hydrogel contact lens of any one of embodiments 1 to 29, wherein said at least one hydrophilic vinylic monomer comprises N-vinylpyrrolidone and/or N-vinyl-N-methyl acetamide.

32. The UV/HEVL-filtering silicone hydrogel contact lens of any one of embodiments 1 to 31, wherein said at least one hydrophilic vinylic monomer comprises a hydrophilic (meth)acrylamido monomer selected from the group consisting of (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, poly(ethylene glycol)ethyl (meth)acrylamide having a number average molecular weight of up to 1500, 2-(meth)acrylamidoglycolic acid, 3-(meth)acrylamidopropionic acid, 5-(meth)acrylamidopentanoic acid, 4-(meth)acrylamidobutanoic acid, 3-(meth)acrylamido-2-methylbutanoic acid, 3-(meth)acrylamido-3-methylbutanoic acid, 2-(meth)acrylamido-2methyl-3,3-dimethyl butanoic acid, 3-(meth)acrylamidohaxanoic acid, 4-(meth)acrylamido-3,3-dimethylhexanoic acid, N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-3-aminopropyl (meth)acrylamide, N-3-methylaminopropyl (meth)acrylamide, N-3-dimethylaminopropyl (meth)acrylamide, methoxy-poly(ethylene glycol)ethyl (meth)acrylamide having a number average molecular weight of up to 1500, and combinations thereof.

33. The UV/HEVL-filtering silicone hydrogel contact lens of any one of embodiments 1 to 31, wherein said at least one hydrophilic vinylic monomer comprises a hydrophilic (meth)acrylamido monomer selected from the group consisting of (meth)acrylamide, N,N-dimethyl (meth)acrylamide, N-ethyl (meth)acrylamide, N-propyl (meth)acrylamide, N-isopropyl (meth)acrylamide, N-3-methoxypropyl (meth)acrylamide, N-2-hydroxylethyl (meth)acrylamide, N-3-hydroxypropyl (meth)acrylamide, and combinations thereof.

34. The UV/HEVL-filtering silicone hydrogel contact lens of any one of embodiments 1 to 33, wherein said at least one hydrophilic vinylic monomer comprises a hydroxy-containing vinylic monomer selected from the group consisting of hydroxyethyl (meth)acrylate, glycerol (meth)acrylate, 3-hydroxypropyl (meth)acrylate, 2-hydroxypropyl (meth)acrylate, 3-amino-2-hydroxypropyl (meth)acrylate, N-2-hydroxyethyl (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, vinyl alcohol, allyl alcohol, and combinations thereof.

35. The UV/HEVL-filtering silicone hydrogel contact lens of any one of embodiments 1 to 34, wherein said at least one hydrophilic vinylic monomer comprises a methylene-containing pyrrolidone monomer selected from the group consisting of 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, and combinations thereof.

36. The UV/HEVL-filtering silicone hydrogel contact lens of any one of embodiments 1 to 35, wherein the UV/HEVL-filtering silicone hydrogel contact lens has an oxygen permeability of at least 60 barrers (at about 35° C.) when being fully hydrated.

37. The UV/HEVL-filtering silicone hydrogel contact lens of any one of embodiments 1 to 35, wherein the UV/HEVL-filtering silicone hydrogel contact lens has an oxygen permeability of at least 70 barrers (at about 35° C.) when being fully hydrated.

38. The UV/HEVL-filtering silicone hydrogel contact lens of any one of embodiments 1 to 35, wherein the UV/HEVL-filtering silicone hydrogel contact lens has an oxygen permeability of at least 80 barrers (at about 35° C.) when being fully hydrated.

39. The UV/HEVL-filtering silicone hydrogel contact lens of any one of embodiments 1 to 38, wherein the UV/HEVL-filtering silicone hydrogel contact lens has an elastic modulus of about 2.0 MPa or less (at a temperature of from 22° C. to 28° C.) when being fully hydrated.

40. The UV/HEVL-filtering silicone hydrogel contact lens of any one of embodiments 1 to 38, wherein the UV/HEVL-filtering silicone hydrogel contact lens has an elastic modulus of about 1.5 MPa or less (at a temperature of from 22° C. to 28° C.) when being fully hydrated.

41. The UV/HEVL-filtering silicone hydrogel contact lens of any one of embodiments 1 to 38, wherein the UV/HEVL-filtering silicone hydrogel contact lens has an elastic modulus of about 1.2 or less (at a temperature of from 22° C. to 28° C.) when being fully hydrated.

42. The UV/HEVL-filtering silicone hydrogel contact lens of any one of embodiments 1 to 38, wherein the UV/HEVL-filtering silicone hydrogel contact lens has an elastic modulus of from about 0.4 MPa to about 1.0 MPa (at a temperature of from 22° C. to 28° C.) when being fully hydrated.

43. The UV/HEVL-filtering silicone hydrogel contact lens of any one of embodiments 1 to 42, wherein the UV/HEVL-filtering silicone hydrogel contact lens has a water content of from about 15% to about 70% (at a temperature of from 22° C. to 28° C.) when being fully hydrated.

44. The UV/HEVL-filtering silicone hydrogel contact lens of any one of embodiments 1 to 42, wherein the UV/HEVL-filtering silicone hydrogel contact lens has a water content of from about 20% to about 70% (at a temperature of from 22° C. to 28° C.) when being fully hydrated.

45. The UV/HEVL-filtering silicone hydrogel contact lens of any one of embodiments 1 to 42, wherein the UV/HEVL-filtering silicone hydrogel contact lens has a water content of from about 25% to about 70% (at a temperature of from 22° C. to 28° C.) when being fully hydrated.

46. The UV/HEVL-filtering silicone hydrogel contact lens of any one of embodiments 1 to 42, wherein the UV/HEVL-filtering silicone hydrogel contact lens has a water content of from about 30% to about 65% (at a temperature of from 22° C. to 28° C.) when being fully hydrated.

47. The UV/HEVL-filtering silicone hydrogel contact lens of any one of embodiments 1 to 46, wherein the bulk silicone hydrogel material further comprises at least one non-silicone vinylic crosslinker.

48. The UV/HEVL-filtering silicone hydrogel contact lens of embodiment 47, wherein said at least one non-silicone vinylic crosslinker comprises ethyleneglycol di-(meth)acrylate, diethyleneglycol di-(meth)acrylate, triethyleneglycol di-(meth)acrylate, tetraethyleneglycol di-(meth)acrylate, glycerol di-(meth)acrylate, 1,3-propanediol di-(meth)acrylate, 1,3-butanediol di-(meth)acrylate, 1,4-butanediol di-(meth)acrylate, glycerol 1,3-diglycerolate di-(meth)acrylate, ethylenebis[oxy(2-hydroxypropane-1,3-diyl)] di-(meth)acrylate, bis[2-(meth)acryloxyethyl]phosphate, trimethylolpropane di-(meth)acrylate, and 3,4-bis[(meth)acryloyl]tetrahydrofuan, diacrylamide, dimethacrylamide, N,N-di(meth)acryloyl-N-methylamine, N,N-di(meth)acryloyl-N-ethylamine, N,N′-methylene bis(meth)acrylamide, N,N′-ethylene bis(meth)acrylamide, N,N′-dihydroxyethylene bis(meth)acrylamide, N,N′-propylene bis(meth)acrylamide, N,N′-2-hydroxypropylene bis(meth)acrylamide, N,N′-2,3-dihydroxybutylene bis(meth)acrylamide, 1,3-bis(meth)acrylamidepropane-2-yl dihydrogen phosphate, piperazine diacrylamide, tetraethyleneglycol divinyl ether, triethyleneglycol divinyl ether, diethyleneglycol divinyl ether, ethyleneglycol divinyl ether, triallyl isocyanurate, triallyl cyanurate, trimethylopropane trimethacrylate, pentaerythritol tetramethacrylate, bisphenol A dimethacrylate, allylmethacrylate, allylacrylate, N-allyl-methacrylamide, N-allyl-acrylamide, or combinations thereof.

49. The UV/HEVL-filtering silicone hydrogel contact lens of any one of embodiments 1 to 48, wherein the bulk silicone hydrogel material further comprises repeating units of at least one hydrophobic non-silicone vinylic monomer.

50. The UV/HEVL-filtering silicone hydrogel contact lens of embodiment 49, wherein said at least one hydrophobic non-silicone vinylic monomer comprises C₁-C₁₀ alkyl (meth)acrylate, cyclopentylacrylate, cyclohexylmethacrylate, cyclohexylacrylate, isobornyl (meth)acrylate, styrene, 4,6-trimethylstyrene (TMS), t-butyl styrene (TBS), trifluoroethyl (meth)acrylate, hexafluoro-isopropyl (meth)acrylate, hexafluorobutyl (meth)acrylate, or combinations thereof.

51. The UV/HEVL-filtering silicone hydrogel contact lens of embodiment 27, wherein the bulk silicone hydrogel material comprises: repeating units of at least one polysiloxane vinylic monomer; repeating units of at least one hydrophilic N-vinyl amide monomer selected from the group consisting of N-vinylpyrrolidone, N-vinyl piperidone, N-vinyl caprolactam, N-vinyl-N-methyl acetamide, N-vinyl formamide, N-vinyl acetamide, N-vinyl isopropylamide, N-vinyl-N-methyl acetamide, N-vinyl-N-ethyl acetamide, N-vinyl-N-ethyl formamide, and mixtures thereof; repeating units of at least one non-silicone vinylic crosslinker; repeating units of at least one hydrophobic non-silicone vinylic monomer selected from the group consisting of C₁-C₁₀ alkyl (meth)acrylate, cyclopentylacrylate, cyclohexylmethacrylate, cyclohexylacrylate, isobornyl (meth)acrylate, styrene, 4,6-trimethylstyrene (TMS), t-butyl styrene (TBS), trifluoroethyl (meth)acrylate, hexafluoro-isopropyl (meth)acrylate, hexafluorobutyl (meth)acrylate, and combinations thereof.

52. The UV/HEVL-filtering silicone hydrogel contact lens of embodiment 51, wherein said at least one hydrophilic N-vinyl amide monomer is N-vinylpyrrolidone and/or N-vinyl-N-methyl acetamide, wherein said at least one hydrophobic non-silicone vinylic monomer is methyl methacrylate, wherein said at least one non-silicone vinylic crosslinker comprises ethyleneglycol di-(meth)acrylate, diethyleneglycol di-(meth)acrylate, triethyleneglycol di-(meth)acrylate, tetraethyleneglycol di-(meth)acrylate, glycerol di-(meth)acrylate, triallyl isocyanurate, allyl methacrylate, or combinations thereof.

53. The UV/HEVL-filtering silicone hydrogel contact lens of any one of embodiments 1 to 18, wherein the bulk silicone hydrogel material in dried state comprises at least 90% by weight of repeating units of (a) at least hydrophilic (meth)acrylamido monomer as said at least one hydrophilic vinylic monomer; (b) at least one siloxane-containing (meth)acrylamido monomer as said at least one siloxane-containing vinylic monomer; and (c) said at least one polysiloxane vinylic monomer.

54. The UV/HEVL-filtering silicone hydrogel contact lens of embodiment 53, wherein said at least one hydrophilic (meth)acrylamido monomer comprises (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-4-hydroxybutyl (meth)acrylamide, N,N-bis(2-hydroxyethyl) (meth)acrylamide, N-tris(hydroxymethyl) methyl (meth)acrylamide, 2-(meth)acrylamidoglycolic acid, 3-(meth)acrylamido-propionic acid, 4-(meth)acrylamido-butanoic acid, 3-(meth)acrylamido-2-methylbutanoic acid, 3-(meth)acrylamido-3-methylbutanoic acid, 2-(meth)acrylamido-2-methyl-3,3-dimethyl butanoic acid, 5-(meth)acrylamidopentanoic acid, 3-(meth)acrylamidohaxanoic acid, 4-(meth)acrylamido-3,3-dimethylhexanoic acid, (3-(meth)acrylamidophenyl)boronic acid, 3-((3-methacrylamidopropyl)dimethylammonio)-propane-1-sulfonate; 3-((3-acrylamidopropyl)dimethylammonio)propane-1-sulfonate, N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-3-aminopropyl (meth)acrylamide, N-3-methylaminopropyl (meth)acrylamide, N-3-dimethylaminopropyl (meth)acrylamide, poly(ethylene glycol)ethyl (meth)acrylamide having a number average molecular weight of up to 700, methoxy-poly(ethylene glycol)ethyl (meth)acrylamide having a number average molecular weight of up to 700, or combination thereof.

55. The UV/HEVL-filtering silicone hydrogel contact lens of embodiment 53, wherein said at least one hydrophilic (meth)acrylamido monomer comprises N,N-dimethyl (meth)acrylamide, N-ethyl (meth)acrylamide, N-2-hydroxyethyl (meth)acrylamide, N-3-hydroxypropyl (meth)acrylamide, N-2-hydroxypropyl (meth)acrylamide, N-2,3-dihydroxypropyl (meth)acrylamide, (meth)acrylamide, N-(2-aminoethyl)(meth)acrylamide, N-(3-aminopropyl)(meth)acrylamide, or combinations thereof, more preferably is N,N-dimethylacrylamide.

56. The UV/HEVL-filtering silicone hydrogel contact lens of embodiment 53, wherein said at least one hydrophilic (meth)acrylamido monomer comprises N,N-dimethyl (meth)acrylamide.

57. The UV/HEVL-filtering silicone hydrogel contact lens of any one of embodiments 53 to 56, wherein said at least one siloxane-containing (meth)acrylamido monomer comprises a (meth)acrylamido monomer containing a tris(trialkylsiloxy)silyl group.

58. The UV/HEVL-filtering silicone hydrogel contact lens of embodiment 57, wherein the (meth)acrylamido monomer containing a tris(trialkylsiloxy)silyl group is N-[tris(trimethylsiloxy)silylpropyl] (meth)acrylamide, N-[tris(dimethylethylsiloxy)-silylpropyl](meth)acrylamide, N-[tris(dimethylpropylsiloxy)silylpropyl]acrylamide, N-[tris(dimethylphenylsiloxy)silylpropyl] (meth)acrylamide, N-(2-hydroxy-3-(3-(tris(trimethylsilyloxy)silyl)propyloxy)propyl)-2-methyl acrylamide, N-(2-hydroxy-3-(3-(tris(trimethylsilyloxy)silyl)propyloxy)propyl) acrylamide, N,N-bis[2-hydroxy-3-(3-(tris(trimethylsilyloxy)silyl)propyloxy)propyl]-2-methyl acrylamide, N,N-bis[2-hydroxy-3-(3-(tris(trimethylsilyloxy)silyl)propyloxy)propyl] acrylamide, or a combination thereof.

59. The UV/HEVL-filtering silicone hydrogel contact lens of any one of embodiments 53 to 56, wherein said at least one siloxane-containing (meth)acrylamido monomer comprises a (meth)acrylamido monomer containing a bis(trialkylsilyloxy)alkylsilyl group.

60. The UV/HEVL-filtering silicone hydrogel contact lens of any one of embodiments 53 to 56, wherein said at least one siloxane-containing (meth)acrylamido monomer comprises a (meth)acrylamido monomer containing a polysiloxane segment having 2 to 20 siloxane units.

61. The UV/HEVL-filtering silicone hydrogel contact lens of any one of embodiments 53 to 60, wherein said at least one polysiloxane vinylic crosslinker comprises: an α,ω-(meth)acryloxy-terminated polydimethylsiloxane; an α,ω-(meth)acrylamido-terminated polydimethylsiloxane; an α,ω-vinyl carbonate-terminated polydimethylsiloxane; an α,ω-vinyl carbamate-terminated polydimethylsiloxane; a bis-3-methacryloxy-2-hydroxypropyloxypropyl polydimethylsiloxane; N,N,N′,N′-tetrakis(3-methacryloxy-2-hydroxypropyl)-alpha,omega-bis-3-aminopropyl-polydimethylsiloxane of various molecular weight; a reaction product of glycidyl methacrylate with a di-amino-functionalized polydimethylsiloxane; a reaction product of an azlactone-containing vinylic monomer with a d-hydroxyl-functionalized polydimethylsiloxane; or combinations thereof.

62. The UV/HEVL-filtering silicone hydrogel contact lens of any one of embodiments 53 to 60, wherein said at least one polysiloxane vinylic crosslinker comprises: (1) a vinylic crosslinker which comprises one sole polydiorganosiloxane segment and two terminal ethylenically-unsaturated groups selected from the group consisting of (meth)acryloyloxy groups, (meth)acryloylamino groups, vinyl carbonate groups, vinylcarbamate groups; and/or (2) a chain-extended polysiloxane vinylic crosslinker which comprises at least two polydiorganosiloxane segment and a covalent linker between each pair of polydiorganosiloxane segments and two two terminal ethylenically-unsaturated groups selected from the group consisting of (meth)acryloyloxy groups, (meth)acryloylamino groups, vinyl carbonate groups, vinylcarbamate groups.

63. The UV/HEVL-filtering silicone hydrogel contact lens of any one of embodiments 53 to 60, wherein said at least one polysiloxane vinylic crosslinker comprises α,ω-bis[3-(meth)acrylamido-propyl]-terminated polydimethylsiloxane, α,ω-bis[3-(meth)acryloxypropyl]-terminated polydimethylsiloxane, α,ω-bis[3-(meth)acryloxy-2-hydroxypropyloxypropyl]-terminated polydimethylsiloxane, α,ω-bis[3-(meth)acryloxyethoxy-2-hydroxypropyloxypropyl]-terminated polydimethylsiloxane, α,ω-bis[3-(meth)acryloxypropyloxy-2-hydroxypropyloxypropyl]-terminated polydimethylsiloxane, α,ω-bis[3-(meth)acryloxy-isopropyloxy-2-hydroxypropyloxypropyl]-terminated polydimethylsiloxane, α,ω-bis[3-(meth)acryloxybutyloxy-2-hydroxypropyloxypropyl]-terminated polydimethylsiloxane, α,ω-bis[3-(meth)acrylamidoethoxy-2-hydroxypropyloxypropyl]-terminated polydimethylsiloxane, α,ω-bis[3-(meth)acrylamidopropyloxy-2-hydroxypropyloxy-propyl]-terminated polydimethylsiloxane, α,ω-bis[3-(meth)acrylamidoisopropyloxy-2-hydroxypropyloxypropyl]-terminated polydimethylsiloxane, α,ω-bis[3-(meth)acrylamidobutyloxy-2-hydroxypropyloxypropyl]-terminated polydimethylsiloxane, α,ω-bis[3-(meth)acryloxy-ethylamino-2-hydroxypropyloxypropyl]-terminated polydimethylsiloxane, α,ω-bis[3-(meth)acryloxypropylamino-2-hydroxypropyloxypropyl]-terminated polydimethylsiloxane, α,ω-bis[3-(meth)acryloxybutylamino-2-hydroxypropyloxypropyl]-terminated polydimethylsiloxane, α,ω-bis[(meth)acrylamidoethylamino-2-hydroxypropyloxy-propyl]-terminated polydimethylsiloxane, α,ω-bis[3-(meth)acrylamidopropylamino-2-hydroxypropyloxypropyl]-terminated polydimethylsiloxane, α,ω-bis[3-(meth)acrylamide-butylamino-2-hydroxypropyloxy-propyl]-terminated polydimethylsiloxane, α,ω-bis[(meth)acryloxy-2-hydroxypropyloxy-ethoxypropyl]-terminated polydimethylsiloxane, α,ω-bis[(meth)acryloxy-2-hydroxypropyl-N-ethylaminopropyl]-terminated polydimethylsiloxane, α,ω-bis[(meth)acryloxy-2-hydroxypropyl-aminopropyl]-polydimethylsiloxane, α,ω-bis[(meth)acryloxy-2-hydroxypropyloxy-(polyethylenoxy)propyl]-terminated polydimethylsiloxane, α,ω-bis[(meth)acryloxyethylamino-carbonyloxy-ethoxypropyl]-terminated polydimethylsiloxane, α,ω-bis[(meth)acryloxyethylamino-carbonyloxy-(polyethylenoxy)propyl]-terminated polydimethylsiloxane, or combinations thereof.

64. A method for producing HEVL-filtering silicone hydrogel contact lenses, comprising the steps of:
(I) obtaining a mold, wherein the mold has a first mold half with a first molding surface defining the anterior surface of a contact lens and a second mold half with a second molding surface defining the posterior surface of the contact lens, wherein said first and second mold halves are configured to receive each other such that a cavity is formed between said first and second molding surfaces;
(II) introducing a polymerizable composition into the cavity, wherein the polymerizable composition comprises (1) at least one hydrophilic vinylic monomer, (2) at least one siloxane-containing vinylic monomer and/or at least one polysiloxane vinylic crosslinker, (3) at least one UV-absorbing vinylic monomer having an UV absorption peak at a wavelength of from 280 nm and 380 nm, (4) a first HEVL-absorbing benzotriazole-containing vinylic monomer having a first HEVL absorption peak at a wavelength of from 410 nm and 420 nm, (5) a second HEVL-absorbing benzotriazole-containing vinylic monomer that has a second HEVL absorption peak at a wavelength of from 415 nm and 425 nm, (6) from about 100 ppm to about 350 ppm of a polymerizable blue dye, (7) from about 0.2% to about 1.5% by weight of at least one free-radical initiator, and (8) optionally at least one component selected from the group consisting of at least one hydrophobic non-silicone vinylic monomer, at least one non-silicone vinylic crosslinker, a leachable lubricant, a leachable tear-stabilizing agent, and combinations thereof, wherein said components (3), (4) and (5) are present in the polymerizable composition in amounts and at a ratio for rendering the UV/HEVL-filtering contact lens to have a UVA % T of less than 5%, UVB % T of about 1% or less, a HEVL % T of about 35% or less, a % T at 410 nm of about 15% or less, a % T at 430 nm of about 60% or less, a % T at 450 nm of about 85% or greater, and a color expressed with a*≤−5 and b*≤+18; and
(III) curing the polymerizable composition in the mold to form a UV/HEVL-filtering silicone hydrogel contact lens precursor; removing the UV/HEVL-filtering silicone hydrogel contact lens precursor from the mold; and
(IV) subjecting the UV/HEVL-filtering silicone hydrogel contact lens precursor to one or more post-molding processes selected from the group consisting of extraction, hydration, surface treatment, packaging, sterilization, and combinations thereof.

65. The method of embodiment 64, wherein said at least one polymerizable blue dye is 1,4-bis((2-methoxyethyl)amino)-anthraquinone and/or 1,4-bis(4-(2-methacryloxyethyl)phenylamino)-anthraquinone.

66. The method of embodiment 64 or 65, wherein said at least one UV-absorbing vinylic monomer comprises 2-(2′-hydroxy-5′-vinylphenyl)-2H-benzotriazole, 2-(2′-hydroxy-5′-methacryloxyphenyl)-2H-benzotriazole, 2-(2′-hydroxy-5′-acryloyloxyphenyl)-2H-benzotriazole, 2-[2′-hydroxy-5′-(2-methacryloxyethyl)phenyl)]-2H-benzotriazole (Norbloc), 2-[2′-hydroxy-5′-(2-acryloxyethyl)phenyl)]-2H-benzotriazole, 2-(2′-hydroxy-5′-methacryloxypropyl-phenyl)-2H-benzotriazole, 2-(2′-hydroxy-5′-acryloxypropylphenyl)-2H-benzotriazole, or combinations thereof.

67. The method of embodiment 64 or 65, wherein said at least one UV-absorbing vinylic monomer is 2-[2′-hydroxy-5′-(2-methacryloxyethyl)phenyl)]-2H-benzotriazole.

68. The method of any one of embodiments 64 to 67, wherein the first HEVL-absorbing benzotriazole-containing vinylic monomer is 2-{2′-Hydroxy-3′-tert-butyl-5′-[3′-methacryloyloxypropoxy]phenyl}-5-chloro-2H-benzotriazole (UV28), wherein the second HEVL-absorbing benzotriazole-containing vinylic monomer is 2-[2′-Hydroxy-3′-tert-butyl-5′-(3′-acryloyloxypropoxy)phenyl]-5-trifluoromethyl-2H-benzotriazole (UV23).

69. The method of any one of embodiments 64 to 68, wherein the polymerizable composition comprises from about 1.2% to about 3.5% by weight of all components (3), (4) and (5) relative to total amount of all polymerizable components.

70. The method of any one of embodiments 64 to 69, wherein weight ratio of component (4) over component (5) is from about 0.25 to about 2.5.

71. The method of any one of embodiments 64 to 70, wherein said at least one free-radical initiator is a thermal initiator, wherein the polymerizable composition is cured thermally.

72. The method of embodiment 71, wherein said at least one hydrophilic vinylic monomer is selected from the group consisting of N-vinylpyrrolidone, N-vinyl piperidone, N-vinyl caprolactam, N-vinyl-N-methyl acetamide, N-vinyl formamide, N-vinyl acetamide, N-vinyl isopropylamide, N-vinyl-N-methyl acetamide, N-vinyl-N-ethyl acetamide, N-vinyl-N-ethyl formamide, and mixtures thereof, wherein the polymerizable composition comprises said at least one siloxane-containing vinylic monomer which is a polysiloxane vinylic monomer, said at least one polysiloxane vinylic crosslinker, said at least one non-silicone vinylic crosslinker, and said at least one hydrophobic non-silicone vinylic monomer.

73. The method of embodiment 72, wherein said at least one hydrophilic N-vinyl amide monomer is N-vinylpyrrolidone and/or N-vinyl-N-methyl acetamide, wherein said at least one hydrophobic non-silicone vinylic monomer is methyl methacrylate, wherein said at least one non-silicone vinylic crosslinker comprises ethyleneglycol di-(meth)acrylate, diethyleneglycol di-(meth)acrylate, triethyleneglycol di-(meth)acrylate, tetraethyleneglycol di-(meth)acrylate, glycerol di-(meth)acrylate, triallyl isocyanurate, allyl methacrylate, or combinations thereof.

74. The method of any one of embodiments 64 to 70, wherein said at least one free-radical initiator is a visible light photoinitiator, wherein the polymerizable composition is cured with a visible light having a wavelength of from 450 nm to 510 nm.

75. The method of embodiment 74, wherein the visible light photoinitiator is a benzoylphosphine photoinitiator, an acyl germanium photoinitiator, and/or an acyltin photoinitiator.

76. The method of embodiment 74, wherein the visible light photoinitiator is an acyl germanium photoinitiator.

77. The method of any one of embodiments 74 to 76, wherein the polymerizable composition comprises at least 90% by weight of repeating units of (a) at least hydrophilic (meth)acrylamido monomer as said at least one hydrophilic vinylic monomer; (b) at least one siloxane-containing (meth)acrylamido monomer as said at least one siloxane-containing vinylic monomer; and (c) said at least one polysiloxane vinylic monomer, relative to total amount of all polymerizable components.

78. The method of embodiment 77, wherein said at least one hydrophilic (meth)acrylamido monomer comprises (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-4-hydroxybutyl (meth)acrylamide, N,N-bis(2-hydroxyethyl) (meth)acrylamide, N-tris(hydroxymethyl) methyl (meth)acrylamide, 2-(meth)acrylamidoglycolic acid, 3-(meth)acrylamido-propionic acid, 4-(meth)acrylamido-butanoic acid, 3-(meth)acrylamido-2-methylbutanoic acid, 3-(meth)acrylamido-3-methylbutanoic acid, 2-(meth)acrylamido-2-methyl-3,3-dimethyl butanoic acid, 5-(meth)acrylamidopentanoic acid, 3-(meth)acrylamidohaxanoic acid, 4-(meth)acrylamido-3,3-dimethylhexanoic acid, (3-(meth)acrylamidophenyl)boronic acid, 3-((3-methacrylamidopropyl)dimethylammonio)-propane-1-sulfonate; 3-((3-acrylamidopropyl)dimethylammonio)propane-1-sulfonate, N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-3-aminopropyl (meth)acrylamide, N-3-methylaminopropyl (meth)acrylamide, N-3-dimethylaminopropyl (meth)acrylamide, poly(ethylene glycol)ethyl (meth)acrylamide having a number average molecular weight of up to 700, methoxy-poly(ethylene glycol)ethyl (meth)acrylamide having a number average molecular weight of up to 700, or combination thereof.

79. The method of embodiment 77, wherein said at least one hydrophilic (meth)acrylamido monomer comprises N,N-dimethyl (meth)acrylamide, N-ethyl (meth)acrylamide, N-2-hydroxyethyl (meth)acrylamide, N-3-hydroxypropyl (meth)acrylamide, N-2-hydroxypropyl (meth)acrylamide, N-2,3-dihydroxypropyl (meth)acrylamide, (meth)acrylamide, N-(2-aminoethyl)(meth)acrylamide, N-(3-aminopropyl)(meth)acrylamide, or combinations thereof, more preferably is N,N-dimethylacrylamide.

80. The method of embodiment 77, wherein said at least one hydrophilic (meth)acrylamido monomer comprises N,N-dimethyl (meth)acrylamide.

81. The method of any one of embodiments 77 to 80, wherein said at least one siloxane-containing (meth)acrylamido monomer comprises a (meth)acrylamido monomer containing a tris(trialkylsiloxy)silyl group.

82. The method of embodiment 81, wherein the (meth)acrylamido monomer containing a tris(trialkylsiloxy)silyl group is N-[tris(trimethylsiloxy)silylpropyl] (meth)acrylamide, N-[tris(dimethylethylsiloxy)-silylpropyl] (meth)acrylamide, N-[tris(dimethylpropylsiloxy)-silylpropyl]acrylamide, N-[tris(dimethylphenylsiloxy)silylpropyl] (meth)acrylamide, N-(2-hydroxy-3-(3-(tris(trimethylsilyloxy)silyl)propyloxy)propyl)-2-methyl acrylamide, N-(2-hydroxy-3-(3-(tris(trimethylsilyloxy)silyl)propyloxy)propyl) acrylamide, N,N-bis[2-hydroxy-3-(3-(tris(trimethylsilyloxy)silyl)propyloxy)propyl]-2-methyl acrylamide, N,N-bis[2-hydroxy-3-(3-(tris(trimethylsilyloxy)silyl)propyloxy)propyl] acrylamide, or a combination thereof.

83. The method of any one of embodiments 77 to 80, wherein said at least one siloxane-containing (meth)acrylamido monomer comprises a (meth)acrylamido monomer containing a bis(trialkylsilyloxy)alkylsilyl group.

84. The method of any one of embodiments 77 to 80, wherein said at least one siloxane-containing (meth)acrylamido monomer comprises a (meth)acrylamido monomer containing a polysiloxane segment having 2 to 20 siloxane units.

85. The method of any one of embodiments 77 to 84, wherein said at least one polysiloxane vinylic crosslinker comprises: an α,ω-(meth)acryloxy-terminated polydimethylsiloxane; an α,ω-(meth)acrylamido-terminated polydimethylsiloxane; an α,ω-vinyl carbonate-terminated polydimethylsiloxane; an α,ω-vinyl carbamate-terminated polydimethylsiloxane; a bis-3-methacryloxy-2-hydroxypropyloxypropyl polydimethylsiloxane; N,N,N′,N′-tetrakis(3-methacryloxy-2-hydroxypropyl)-alpha,omega-bis-3-aminopropyl-polydimethylsiloxane of various molecular weight; a reaction product of glycidyl methacrylate with a di-amino-functionalized polydimethylsiloxane; a reaction product of an azlactone-containing vinylic monomer with a d-hydroxyl-functionalized polydimethylsiloxane; or combinations thereof.

86. The method of any one of embodiments 77 to 84, wherein said at least one polysiloxane vinylic crosslinker comprises: (1) a vinylic crosslinker which comprises one sole polydiorganosiloxane segment and two terminal ethylenically-unsaturated groups selected from the group consisting of (meth)acryloyloxy groups, (meth)acryloylamino groups, vinyl carbonate groups, vinylcarbamate groups; and/or (2) a chain-extended polysiloxane vinylic crosslinker which comprises at least two polydiorganosiloxane segment and a covalent linker between each pair of polydiorganosiloxane segments and two two terminal ethylenically-unsaturated groups selected from the group consisting of (meth)acryloyloxy groups, (meth)acryloylamino groups, vinyl carbonate groups, vinylcarbamate groups.

87. The method of any one of embodiments 77 to 84, wherein said at least one polysiloxane vinylic crosslinker comprises α,ω-bis[3-(meth)acrylamidopropyl]-terminated polydimethylsiloxane, α,ω-bis[3-(meth)acryloxypropyl]-terminated polydimethylsiloxane, α,ω-bis[3-(meth)acryloxy-2-hydroxypropyloxypropyl]-terminated polydimethylsiloxane, α,ω-bis[3-(meth)acryloxyethoxy-2-hydroxypropyloxypropyl]-terminated polydimethylsiloxane, α,ω-bis[3-(meth)acryloxypropyloxy-2-hydroxypropyloxypropyl]-terminated polydimethylsiloxane, α,ω-bis[3-(meth)acryloxy-isopropyloxy-2-hydroxypropyloxypropyl]-terminated polydimethylsiloxane, α,ω-bis[3-(meth)acryloxybutyloxy-2-hydroxypropyloxypropyl]-terminated polydimethylsiloxane, α,ω-bis[3-(meth)acrylamidoethoxy-2-hydroxypropyloxypropyl]-terminated polydimethylsiloxane, α,ω-bis[3-(meth)acrylamidopropyloxy-2-hydroxypropyloxypropyl]-terminated polydimethylsiloxane, α,ω-bis[3-(meth)acrylamidoisopropyloxy-2-hydroxypropyloxypropyl]-terminated polydimethylsiloxane, α,ω-bis[3-(meth)acrylamidobutyloxy-2-hydroxypropyloxypropyl]-terminated polydimethylsiloxane, α,ω-bis[3-(meth)acryloxyethylamino-2-hydroxypropyloxy-propyl]-terminated polydimethylsiloxane, α,ω-bis[3-(meth)acryloxypropylamino-2-hydroxypropyloxypropyl]-terminated polydimethylsiloxane, α,ω-bis[3-(meth)acryloxybutylamino-2-hydroxypropyloxypropyl]-terminated polydimethylsiloxane, α,ω-bis[(meth)acrylamido-ethylamino-2-hydroxypropyloxy-propyl]-terminated polydimethylsiloxane, α,ω-bis[3-(meth)acrylamidopropylamino-2-hydroxypropyloxypropyl]-terminated polydimethylsiloxane, α,ω-bis[3-(meth)acrylamide-butylamino-2-hydroxypropyloxypropyl]-terminated polydimethylsiloxane, α,ω-bis[(meth)acryloxy-2-hydroxypropyloxy-ethoxypropyl]-terminated polydimethylsiloxane, α,ω-bis[(meth)acryloxy-2-hydroxypropyl-N-ethylaminopropyl]-terminated polydimethylsiloxane, α,ω-bis[(meth)acryloxy-2-hydroxypropyl-aminopropyl]-polydimethylsiloxane, α,ω-bis[(meth)acryloxy-2-hydroxypropyloxy-(polyethylenoxy)propyl]-terminated polydimethylsiloxane, α,ω-bis[(meth)acryloxyethylamino-carbonyloxy-ethoxypropyl]-terminated polydimethylsiloxane, α,ω-bis[(meth)acryloxyethylamino-carbonyloxy-(polyethylenoxy)propyl]-terminated polydimethylsiloxane, or combinations thereof.

The previous disclosure will enable one having ordinary skill in the art to practice the invention. Various modifications, variations, and combinations can be made to the various embodiment described herein. In order to better enable the reader to understand specific embodiments and the advantages thereof, reference to the following examples is suggested. It is intended that the specification and examples be considered as exemplary.

### Example 1

### Oxygen Permeability Measurements

Unless specified, the oxygen transmissibility (Dk/t), the intrinsic (or edge-corrected) oxygen permeability (Dkᵢ or Dk_{c}) of a lens and a lens material are determined according to procedures described in ISO 18369-4.

### Equilibrium Water Content

The equilibrium water content (EWC) of contact lenses are determined as follows.

Amount of water (expressed as percent by weight) present in a hydrated hydrogel contact lens, which is fully equilibrated in saline solution, is determined at room temperature. Quickly stack the lenses, and transfer the lens stack to the aluminum pan on the analytical balance after blotting lens in a cloth. The number of lenses for each sample pan is typically five (5). Record the pan plus hydrated weight of the lenses. Cover the pan with aluminum foil. Place pans in a laboratory oven at 100±2° C. to dry for 16-18 hours. Remove pan plus lenses from the oven and cool in a desiccator for at least 30 minutes. Remove a single pan from the desiccator, and discard the aluminum foil. Weigh the pan plus dried lens sample on an analytical balance. Repeat for all pans. The wet and dry weight of the lens samples can be calculated by subtracting the weight of the empty weigh pan.

### Elastic Modulus

The elastic modulus of a contact lens is determined using a MTS insight instrument. The contact lens is first cut into a 3.12 mm wide strip using Precision Concept two stage cutter. Five thickness values are measured within 6.5 mm gauge length. The strip is mounted on the instrument grips and submerged in PBS (phosphate buffered saline) with the temperature controlled at 21±2° C. Typically 5N Load cell is used for the test. Constant force and speed is applied to the sample until the sample breaks. Force and displacement data are collected by the TestWorks software. The elastic modulus value is calculated by the TestWorks software which is the slope or tangent of the stress vs. strain curve near zero elongation, in the elastic deformation region.

### Transmittance

Contact lenses are manually placed into a specially fabricated sample holder or the like which can maintain the shape of the lens as it would be when placing onto eye. This holder is then submerged into a 1 cm path-length quartz cell containing phosphate buffered saline (PBS, pH ˜7.0-7.4) as the reference. A UV/visible spectrophotmeter, such as, Varian Cary 3E UV-Visible Spectrophotometer with a LabSphere DRA-CA-302 beam splitter or the like, can be used in this measurement. Percent transmission spectra are collected at a wavelength range of 250-800 nm with % T values collected at 1.0 nm intervals. This data is transposed onto an Excel spreadsheet and used to determine if the lenses conform to Class 1 UV absorbance. Transmittance is calculated using the following equations:

$$UVA \% T = Average \% Transmission between 315 nm and 380 nm \times 100$$

$$UVB \% T = Average \% Transmission between 280 nm and 315 nm \times 100$$

$$HEVL \% T = Average \% Transmission between 380 nm and 450 nm \times 100.$$

### Chemicals

CE-PDMS represents a polysiloxane vinylic crosslinker (Mw=10.1 K determined by H¹ NMR spectroscopy) which has three polydimethylsiloxane (PDMS) segments linked via diurethane linkages between two PDMS segments and two urethane linkages each located between one terminal methacrylate group and one PDMS segment and is prepared according to method similar to what described in Example 2 of U.S. Pat. No. 9,315,669; TRIS-Am represents N-[tris(trimethylsiloxy)-silylpropyl]acrylamide; MCR-M07 represents monomethacryloxypropyl-terminated butyl terminated polydimethylsiloxane (Mw: 600-800 Daltons); MMA represents methyl methacrylate; NVP represents N-vinylpyrrolidone; EGMA represents ethylene glycol methyl ether methacrylate; TEGDMA represents triethyleneglycol dimethacrylate; AMA represents allyl methacrylate; DMA represent N,N-dimethylacrylamide; L-PEG 2000 represents N-(carbonyl-methoxypolyethylene glycol-2000)-1,2-disteaoyl-sn-glycero-3-phosphoethanolamin, sodium salt; DMPC represents 1,2-dimyristoyl-sn-glycero-3-phosphocholine; H-TEMPO represents 4-hydroxy-2,2,6,6-tetramethylpiperidin-1-oxyl; Norbloc is 2-[2′-hydroxy-5′-(2-methacryloxyethyl)phenyl)]-2H-benzotriazole from Aldrich; PrOH represents n-propanol; UV28 represents 2-{2′-Hydroxy-3′-tert-butyl-5′-[3′-methacryloyloxypropoxy]phenyl}-5-chloro-2H-benzotriazole; UV23 represents 2-[2′-Hydroxy-3′-tert-butyl-5′-(3′-acryloyloxypropoxy)phenyl]-5-trifluoromethyl-2H-benzotriazole; RB247 represents 1,4-bis((2-methacryloxyethyl)amino)-anthraquinone (Reactive Blue 247); VAZO 64 represents 2,2′-dimethyl-2,2′azodipropiononitrile; BMBDE-Ge represents Bis(4-methoxybenzoyl)diethylgermanium; DBDE-Ge represents dibenzoyldiethylgermanium; TEB-Ge represents tetrakis(2-ethylbenzoyl)-germanium; TTMB-Sn represents tetrakis(2,4,6-trimethylbenzoyl)stannane; MEK represents methylethyl ketone; PBS represents a phosphate-buffered saline which has a pH of 7.2±0.2 at 25° C. and contains about 0.044 wt. % NaH₂PO₄·H₂O, about 0.388 wt. % Na₂HPO₄·2H₂O, and about 0.79 wt. % NaCl and 98.78% water; wt. % represents weight percent; “G1” represents a di-methacryloyloxypropyl-terminated polysiloxane (Mn ˜7.5-8.1 K g/mol, OH content ˜1.25-1.55 mmol/g) of formula (A) shown below.

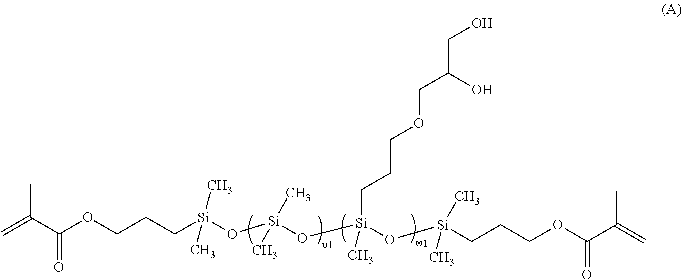

### Example 2

Three HEVL-absorbing vinylic monomers listed in Table 1 are used in this example. They can be represented by the following structural formula of

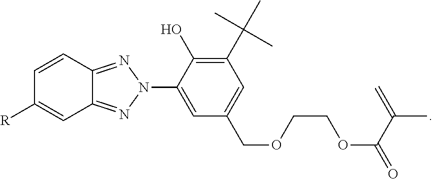

TABLE 1

| | UV29 | UV28 | UV23 |
|---|---|---|---|
| R group | —H | —Cl | —CF₃ |
| σₚₐᵣₐ | 0.00 | 0.23 | 0.54 |
| Absorption Peak (nm) | 404 | 416 | 418 |
| Melting point (° C.) | 104-107 | 112-113 | 89-90 |
| Solubility in PrOH (mg/mL) | 1.3 | 1.5 | > 3.3 |

Table 1 shows that one can shift the HEVL-absorption peak of a HEVL-absorbing vinylic monomer to a longer wavelength and increase its solubility by changing the electron withdrawing or donating ability of the substituent R on the aromatic ring.

It is reported that effects of a change in the electron withdrawing or donating capability of the substituent on the absorption peak can be represented using linear free energy relationships, specifically the Hammett Equation (Jaffe, H. H. Chem. Rev., 1953, 53, 191). Table 1 shows the correlation between the empirical substituent parameter (a) and the shift in the absorbance peak. The more the electron withdrawing character, the more the red shift.

It is also reported that there are correlations between lower melting points and compound solubility (Bathori, N. B. Acta Cryst., 2014, A70, C990). Changing the R group from —Cl to —CF₃ should both shift the absorbance due to a greater electron withdrawing capability, and increase the solubility by reducing the ability of the compound to crystalize due to the bulky —CF₃ group. Table 1 also shows the solubility of these monomers in 1-propanol. UV23 would seem to be a good candidate because the —CF₃ group further red shifts the absorbance and the solubility is much improved.

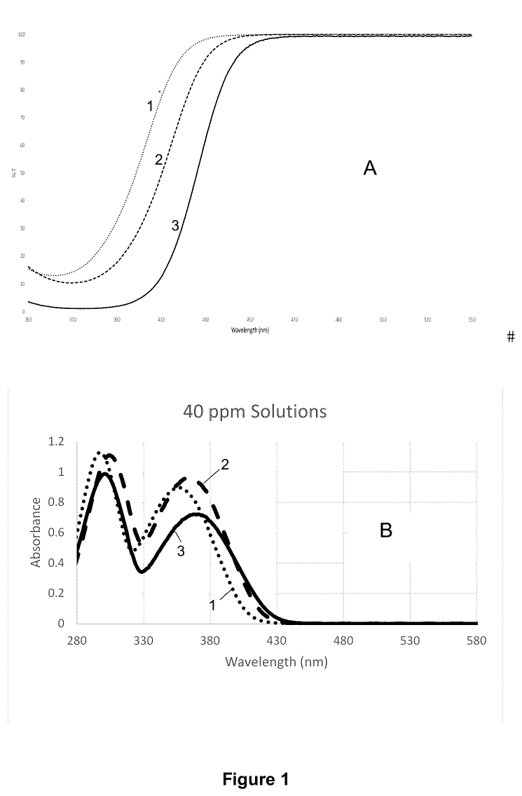

FIG. 1 shows the UV/Vis transmission (A) and absorption spectra of a dilute solution (in PrOH) of UV29, UV28, or UV23 (40 ppm) measured in a 1-cm cell.

### Example 3

### Preparation of Lens Formulations

Two lens formulations are prepared by adding AMA, TEGDMA, MCR-M07, G1, NVP, MMA, EGMA, Norbloc, UV28 (or UV23), RB247, VAZO 64, and t-AA (tert-amyl alcohol) into a clean bottle, with a stir bar to mix at 600 rpm for 30 min at room temperature. After all the solid is dissolved, a filtration of the formulation is carried out by using 2.7 um GMF filter.

Formulation 3-1 (units: part by weight): AMA (0.1), TEGDMA (0.4), MCR-M07 (34), G1 (6), NVP (40), MMA (10), EGMA (10), Norbloc (1.8), UV28 (1.5), RB247 (0.015), VAZO 64 (0.5), and t-AA (1).

Formulation 3-2 (units: part by weight): AMA (0.1), TEGDMA (0.4), MCR-M07 (34), G1 (6), NVP (40), MMA (10), EGMA (10), Norbloc (1.8), UV23 (1.5), RB247 (0.025), VAZO 64 (0.5), and t-AA (1).

Both formulations remain homogenous for couple of days.

### Preparation of PAA Aqueous Solution

An aqueous solution of polyacrylic acid (PAA) is prepared by adding adequate amount of PAA in water (distilled or deionized water). After PAA is fully dissolved, the pH is adjusted by adding ˜1.85% formic acid to the PAA aqueous solution to about 2. The target concentration of PAA is about 0.1% by weight. The prepared PAA aqueous solution is filtered to remove any particulate or foreign matter.

### Phosphate Buffered Saline (PBS)

A phosphate buffered saline is prepared by dissolving NaH₂PO₄·H₂O, Na₂HPO₄·2H₂O, and in a given volume of purified water (distilled or deionized) to have the following composition: ca. 0.044 w/w % NaH₂PO₄·H₂O, ca. 0.388 w/w/% Na₂HPO₄·2H₂O, and ca. 0.79 w/w % NaCl.

In-Package-Coating Saline (IPC saline)

IPC saline is prepared as follows. Poly(AAm-co-AA)(90/10) partial sodium salt, poly(AAm-co-AA) 90/10, Mw 200,000) is purchased from Polysciences, Inc. and used as received. Kymene or PAE solutions of different solid contents is purchased from Ashland as an aqueous solution and used as received. 0.132 w/w % of PAAm-PAA and about 0.11 w/w % of PAE is mixed together in PBS and pre-treated at 65° C. for about 6 hr. After the heat pre-treatment, the IPC saline is cooled down back to room temperature. Up to 5 ppm hydrogen peroxide maybe added to the final IPC saline to prevent bioburden growth and the IPC saline is filtered using a 0.22 micron membrane filter.

### Preparation of UV/HEVL-Filtering SiHy Contact Lenses

A lens formulation is purged with nitrogen at room temperature for 30 to 35 minutes. The N₂-purged lens formulation is introduced into polypropylene molds and thermally cured under the following curing conditions: ramp from room temperature to 55° C. at a ramp rate of about 7° C./minute; holding at 55° C. for about 30 minutes; ramp from 55° C. to 80° C. at a ramp rate of about 7° C./minute; holding at 55° C. for about 30 minutes; ramp from 80° C. to 100° C. at a ramp rate of about 7° C./minute; and holding at 100° C. for about 30 minutes. The molds are opened and the molded SiHy contact lenses are removed from the molds. The SiHy contact lenses are placed in plastic trays. Then the trays with SiHy contact lenses are immersed in the PAA solution prepared above for a about 2 hours and then immersed in PBS prepared above for about 5 minutes to one hour at room temperature for forming PAA-coated SiHy contact lenses. Adequate agitation (e.g. horizontal shaking or up-down movement) is used to ensure appropriate flow of PAA solution and PBS during immersion.

Then, PAA-coated SiHy lenses prepared above are placed in polypropylene lens packaging shells (one lens per shell) with 0.55 mL or 0.65 ml of the IPC saline prepared above (about half of the saline may be added prior to inserting the lens). The blisters are then sealed with foil and autoclaved for about 45 minutes at about 121° C., forming UV/HEVL-filtering SiHy contact lenses with hydrogel coatings thereon.

### Characterization of UV/HEVL-Filtering SiHy Contact Lenses

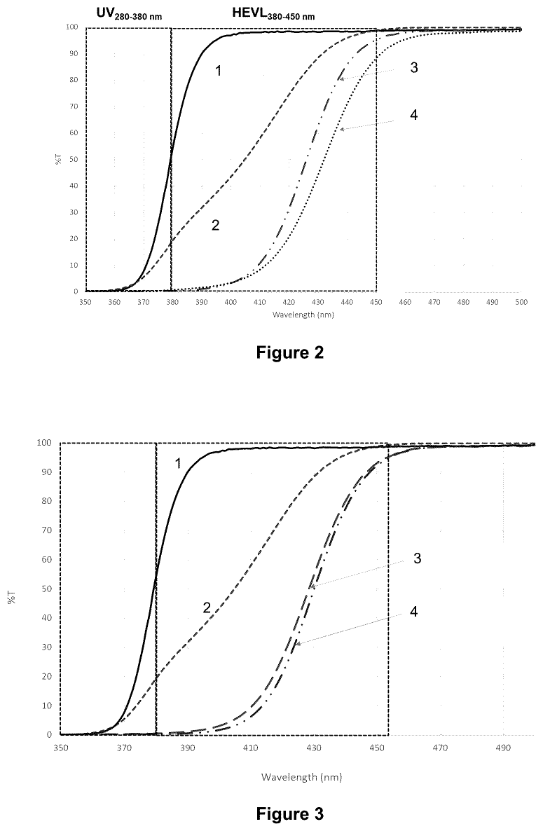

The UV/Vis transmission spectra of UV/HEVL-filtering SiHy lenses (−3.0 D, ˜90 μm center thickness) and two commercial SiHy lenses (Precision1 and TOTAL1 both from Alcon) are shown in FIG. 2.

UV/HEVL-filtering SiHy lenses with 1.5% UV28 (formulation 3-1) have a HEVL % T of 35% and a light green color with 150 ppm RB247. UV/HEVL-filtering SiHy lenses with 1.5% UV23 (formulation 3-2) have a HEVL % T of 28%, but have a color more yellow than that of UV/HEVL-filtering SiHy lenses with 1.5% UV28 even though having a much higher concentration of blue dye (250 ppm RB247).

### Example 4

### Preparation of Lens Formulations

8 lens formulations with compositions shown in Table 2 are prepared by adding AMA, TEGDMA, MCR-M07, G1, NVP, MMA, EGMA, Norbloc, UV28, UV23, RB247, VAZO 64, and t-AA into a clean bottle, with a stir bar to mix at 600 rpm for 30 min at room temperature. After all the solid is dissolved, a filtration of the formulation is carried out by using 2.7 um GMF filter.

TABLE 2

| | Lens formulation No. (parts by weight) | | | | | | | |
|---|---|---|---|---|---|---|---|---|
| | 4-1 | 4-2 | 4-3 | 4-4 | 4-5 | 4-6 | 4-7 | 4-8 |
| AMA | 0.1 | 0.1 | 0.1 | 0.1 | 0.1 | 0.1 | 0.1 | 0.1 |
| TEGDMA | 0.4 | 0.4 | 0.4 | 0.4 | 0.4 | 0.4 | 0.4 | 0.4 |
| MCR-M07 | 34 | 34 | 34 | 34 | 34 | 34 | 34 | 34 |
| G1 | 6 | 6 | 6 | 6 | 6 | 6 | 6 | 6 |
| NVP | 40 | 40 | 40 | 40 | 40 | 40 | 40 | 40 |
| MMA | 10 | 10 | 10 | 10 | 10 | 10 | 10 | 10 |
| EGMA | 10 | 10 | 10 | 10 | 10 | 10 | 10 | 10 |
| Norbloc | 1.8 | 1.8 | 1.8 | 1.8 | 1.8 | 1.8 | 1.8 | 1.8 |
| UV28 | 1.25 | 1.0 | 1.25 | 1.0 | 1.25 | 1.0 | 1.25 | 1.0 |
| UV23 | 0.50 | 0.75 | 0.75 | 1.0 | 0.50 | 0.75 | 0.75 | 1.0 |
| RB247 | 0.0175 | 0.0175 | 0.0175 | 0.0175 | 0.0125 | 0.0125 | 0.0125 | 0.0125 |
| VAZO 64 | 0.5 | 0.5 | 0.5 | 0.5 | 0.5 | 0.5 | 0.5 | 0.5 |
| t-AA | 1 | 1 | 1 | 1 | 1 | 1 | 1 | 1 |

### Preparation of UV/HEVL-Filtering SiHy Contact Lenses

UV/HEVL-filtering SiHy contact lenses are prepared from lens formulations prepared above according to the procedures described in Example 3.

### Characterization of UV/HEVL-Filtering SiHy Contact Lenses

The UV/Vis transmission spectra of 2 types of UV/HEVL-filtering SiHy lenses (−3.0 D, ˜90 μm center thickness) and two commercial SiHy lenses (Precision1 and TOTAL1 both from Alcon) are shown in FIG. 3.

UV/HEVL-filtering SiHy lenses with 1.25% UV28+0.5% UV23 (formulation 4-1) have a HEVL % T of 33%; UV/HEVL-filtering SiHy lenses with 1.00% UV28+0.75% UV23 (formulation 4-2) have a HEVL % T of 32%; UV/HEVL-filtering SiHy lenses with 1.25% UV28+0.75% UV23 (formulation 4-3) have a HEVL % T of 29%; UV/HEVL-filtering SiHy lenses with 1.00% UV28+1.00% UV23 (formulation 4-4) have a HEVL % T of 29%.

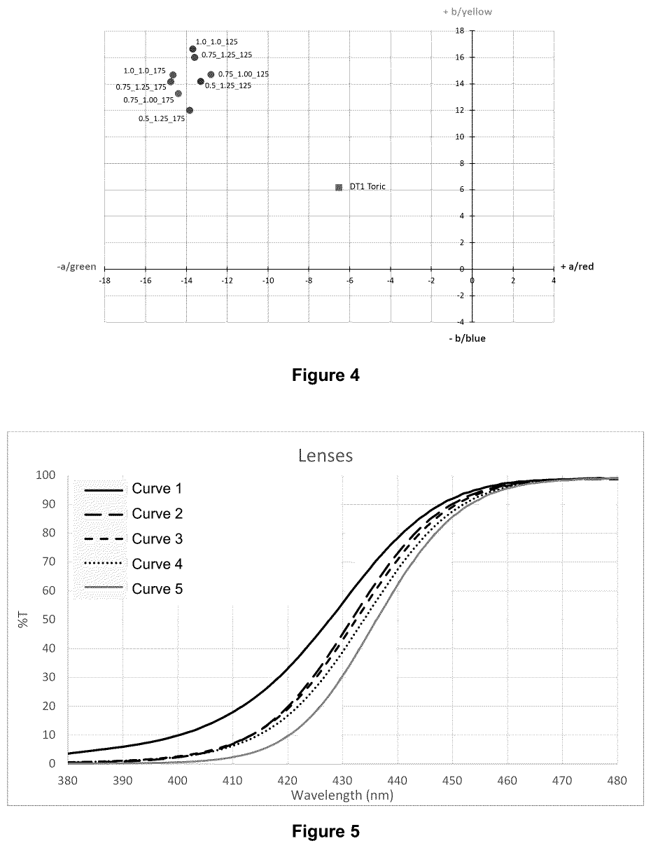

Color measurements by X-rite is shown in FIG. 4.

### Example 5

### Preparation of Lens Formulations

Five lens formulations are prepared to have the following compositions shown in Table 3.

TABLE 3

| | Lens Formulation No. (parts by weight) | | | | |
|---|---|---|---|---|---|
| | 5-1 | 5-2 | 5-3 | 5-4 | 5-5 |
| UV23 | 0.6 | 0.60 | 0.8 | 1.0 | 1.0 |
| UV28 | 0.0 | 0.40 | 0.2 | 0.0 | 0.4 |
| DMA | 23.12 | 23.12 | 23.12 | 23.12 | 23.12 |
| TRIS-Am | 19.85 | 19.85 | 19.85 | 19.85 | 19.85 |
| CE-PDMS | 31.67 | 31.67 | 31.67 | 31.67 | 31.67 |
| Norbloc | 0.60 | 0.60 | 0.60 | 0.60 | 0.60 |
| PrOH | 22.49 | 22.49 | 22.49 | 22.49 | 22.49 |
| BMBDE-Ge | 0.60 | 0.60 | 0.60 | 0.60 | 0.60 |
| LPEG2000 | 0.61 | 0.61 | 0.61 | 0.61 | 0.61 |
| DMPC | 0.76 | 0.76 | 0.76 | 0.76 | 0.76 |
| HO-TEMPO | 0.04 | 0.04 | 0.04 | 0.04 | 0.04 |
| RB247 | 0.0125 | 0.0125 | 0.0125 | 0.0125 | 0.0125 |

All the components (excluding BMBDE-Ge) listed in Table 3 are added into an amber vial. Then under yellow light, BMBDE-Ge is added to the vial and all components are mixed for 30 min in the water bath preheated to 40° C. After all the solid is dissolved, the formulation is filtered with a glass micro filter (5.0 μm Millex®-SV filter).

PAA-coating solution. A polyacrylic acid (PAA) coating solution is prepared by dissolving an amount of PAA (M.W.: 450 kDa, from Lubrizol) in a given volume of 1-propanol (1-PrOH) to have a concentration of about 0.44% by weight and the pH is adjusted with formic acid to about 2.0.

Preparation of In-Package-Coating solution (IPC saline). Poly(AAm-co-AA)(90/10) partial sodium salt (˜90% solid content, poly(AAm-co-AA) 90/10, Mw 200,000) is purchased from Polysciences, Inc. and used as received. Polyamidoamine epichlorohydrin (PAE) (Kymene, an azetidinium content of 0.46 assayed with NMR) is purchased from Ashland as an aqueous solution and used as received. IPC saline is prepared by dissolving about 0.07% w/w of poly(AAm-co-AA)(90/10) and about 0.10% of PAE (an initial azetidinium millimolar equivalents of about 8.8 millimole) in phosphate-buffered saline (PBS) (about 0.044 w/w % NaH₂PO₄·H₂O, about 0.388 w/w/% Na₂HPO₄·2H₂O, about 0.79 w/w % NaCl) and adjusting the pH to 7.2˜7.6. Then the IPC is heat pre-treated for about 6 hours at about 60° C. (heat pretreatment). During this heat pretreatment, poly(AAm-co-AA) and PAE are partially crosslinked to each other (i.e., not consuming all azetidinium groups of PAE) to form a water-soluble and thermally-crosslinkable hydrophilic polymeric material containing azetidinium groups within the branched polymer network in the IPC saline. After the heat pre-treatment, the IPC is cooled to room temperature then filtered using a 0.22 micron PES membrane filter.

### Lens Fabrication

Lenses are prepared by cast-molding from the lens-forming composition prepared above in a reusable mold (quartz female mold half and glass male mold half), similar to the mold shown in FIGS. 1-6 in U.S. Pat. Nos. 7,384,590 and 7,387,759 (FIGS. 1-6). Lens formulation in the molds is cured for 30 seconds with 452 nm LED light at a total intensity of 50 mW/cm². After demolding and delensing, cast-molded contact lenses are then extracted and coated by dipping in the following series of baths: 3 methyl ethyl ketone (MEK) baths (about 22, 78, and 224 seconds respectively); DI water bath (56 seconds); PAA dip solution prepared above (44 seconds); 50/50 n-propanol/water bath (56 seconds); 4 DI water baths (56 seconds each), then equilibrated into PBS solution.

The resultant silicone hydrogel contact lenses are packaged/sealed in polypropylene lens packaging shells (or blisters) (one lens per shell) containing 0.65 mL of IPC saline prepared above and autoclaved for 45 minutes at 121° C.

### Characterization of UV/HEVL-Filtering SiHy Contact Lenses

The UV/Vis transmission spectra of 2 types of UV/HEVL-filtering SiHy lenses (−3.0 D, ˜90 μm center thickness) prepared from the 5 lens formulations are shown in FIG. 5.

The HEVL % T of the HEVL-filtering SiHy contact lenses are reported in Table 4.

TABLE 4

| | HEVL-Filtering SiHy contact | | | | |
|---|---|---|---|---|---|
| | Lens (from Formulation No.) | | | | |
| | 5-1 | 5-2 | 5-3 | 5-4 | 5-5 |
| HEVL % T (%) | 36 | 28 | 27 | 26 | 21 |

UV-vis spectrum of lens containing 0.2% of UV28 (UV/HEVL blocker) is recorded and is presented in FIG. 5.

### Photo-Stability Study of UV/HEVL-Filtering SiHy Contact Lenses

The UV/HEVL-filtering SiHy lenses (−3.0 D, ˜90 μm center thickness) prepared from lens formulation 5-1 are exposed to simulated sunlight for 1, 2, and 8 hours to evaluate their photo-stability (light fastness). There is no change in the UV/Vis transmission spectra from time zero over 8 hours of exposure.

### Example 6

Four different visible light photoinitiators are evaluated for their efficiency in producing quality lenses at a shorter curing time.

Table 5 provides information about the photoinitiators used in this example.

TABLE 5

| Photoinitiator | BMBDE-Ge | DBDE-Ge | TEB-Ge | TTMB-Sn |
|---|---|---|---|---|
| Structure | 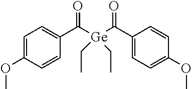 | 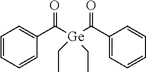 | 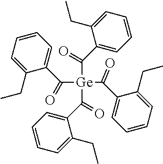 | 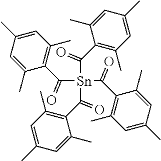 |
| Abs. edge | 470 | 480 | 490 | 510 |
| (nm) | | | | |

### Photo-Rheology Studies

Four lens formulations without HEVL-absorbing benzotriazole-containing vinylic monomers are prepared to have the following compositions shown in Table 6. The photo-rheology data of these 4 lens formulations are also reported in Table 6. TTMB-Sn is not soluble in the formulation at room temperature but is soluble at 40° C. So, the photo-rheology experiment is conducted at 40° C. for this photoinitiator instead of the typical 25° C. (for other three photoinitiators).

TABLE 6

| | 6-1 | 6-2 | 6-3 | 6-4 |
|---|---|---|---|---|
| Photoinitiator | BMBDE-Ge | DBDE-Ge | TEB-Ge | TTMB-Sn |
| DMA | 23.12 | 23.12 | 23.12 | 23.12 |
| TRIS-Am | 19.85 | 19.85 | 19.85 | 19.85 |
| CE-PDMS | 31.67 | 31.67 | 31.67 | 31.67 |
| Norbloc | 0.60 | 0.60 | 0.60 | 0.60 |
| PrOH | 22.49 | 22.49 | 22.49 | 22.49 |
| BMBDE-Ge | 0.60 | 0.60 | 0.60 | 0.60 |
| LPEG2000 | 0.61 | 0.61 | 0.61 | 0.61 |
| DMPC | 0.76 | 0.76 | 0.76 | 0.76 |
| HO-TEMPO | 0.04 | 0.04 | 0.04 | 0.04 |
| LED | 464 nm | | | |
| Intensity (mW/cm²) | 50 | | | |
| Cure Time (s) | 10 | 25 | 10 | 27* |
| G′ (kPa) | 113 | 175 | 113 | 80 |

*Experiment conducted at 40° C. due to solubility issues at lower temperatures.

BMBDE-Ge and TEB-Ge can yield the desired short cure time and G′. They are then formulated with a combination of UV23 and UV28. The formulation details and the photo-rheology data are shown in Table 7. The cure time and the G′ value is nearly identical to each other.

TABLE 7

| | 6-1b | 6-3b |
|---|---|---|
| PI | 0.6 | 0.75 |
| | (BMBDE-Ge) | (TEB-Ge) |
| UV28 | 0.2 | 0.4 |
| UV23 | 0 | 0.6 |
| Norbloc | 0.6 | 0.4 |
| DMA | 23.12 | 23.12 |
| TRIS-Am | 19.91 | 19.11 |
| CE-PDMS | 31.67 | 31.67 |
| PrOH | 22.49 | 22.34 |
| LPEG2000 | 0.61 | 0.61 |
| DMPC | 0.76 | 0.76 |
| HO-TEMPO | 0.04 | 0.04 |
| LED (nm) | 452 | 464 |
| Intensity (mW/cm²) | 50 | |
| Cure Time (s) | 13 | 14 |
| G′ (kPa) | 107 | 105 |

All the publications and patents which have been cited herein above are hereby incorporated by reference in their entireties.

What is claimed is:

1. A UV/HEVL-filtering silicone hydrogel contact lens, comprising a bulk silicone hydrogel material that comprises:
(1) repeating units of at least one hydrophilic vinylic monomer;
(2) repeating units of at least one silicone-containing vinylic monomer and/or at least one polysiloxane vinylic crosslinker;
(3) repeating units of at least one UV-absorbing vinylic monomer having an UV absorption peak at a wavelength of from 280 nm and 380 nm;
(4) repeating units of a first HEVL-absorbing benzotriazole-containing vinylic monomer having a first HEVL absorption peak at a wavelength of from 410 nm and 425 nm;
(5) repeating units of a second HEVL-absorbing benzotriazole-containing vinylic monomer that has a second HEVL absorption peak at a wavelength of from 410 nm and 425 nm, wherein the wavelength of the second HEVL absorption peak is longer than the wavelength of the first HEVL absorption peak; and
(6) from about 90 ppm to about 300 ppm of repeating units of at least one polymerizable blue dye,
wherein said components (3), (4) and (5) are present in the bulk silicone hydrogel material in amounts and at a ratio for rendering the UV/HEVL-filtering contact lens to have a UVA % T of less than 5%, UVB % T of about 1% or less, a HEVL % T of about 35% or less, a % T at 410 nm of about 15% or less, a % T at 430 nm of about 60% or less, and a % T at 450 nm of about 85% or greater, wherein the UV/HEVL-filtering contact lens has a color expressed with a*≤−5 and b*≤+18.

2. The UV/HEVL-filtering silicone hydrogel contact lens of claim 1, wherein said at least one polymerizable blue dye is 1,4-bis((2-methoxyethyl)amino)-anthraquinone and/or 1,4-bis(4-(2-methacryloxyethyl)phenylamino)-anthraquinone.

3. The UV/HEVL-filtering silicone hydrogel contact lens of claim 2, wherein said at least one UV-absorbing vinylic monomer comprises a benzotriazole-containing vinylic monomer.

4. The UV/HEVL-filtering silicone hydrogel contact lens of claim 3, wherein said at least one UV-absorbing vinylic monomer comprises 2-(2′-hydroxy-5′-vinylphenyl)-2H-benzotriazole, 2-(2′-hydroxy-5′-methacryloxyphenyl)-2H-benzotriazole, 2-(2′-hydroxy-5′-acryloyloxyphenyl)-2H-benzotriazole, 2-[2′-hydroxy-5′-(2-methacryloxyethyl)phenyl)]-2H-benzotriazole (Norbloc), 2-[2′-hydroxy-5′-(2-acryloxyethyl)phenyl)]-2H-benzotriazole, 2-(2′-hydroxy-5′-methacryloxypropyl-phenyl)-2H-benzotriazole, 2-(2′-hydroxy-5′-acryloxypropylphenyl)-2H-benzotriazole, or combinations thereof.

5. The UV/HEVL-filtering silicone hydrogel contact lens of claim 3, wherein said at least one UV-absorbing vinylic monomer is 2-[2′-hydroxy-5′-(2-methacryloxyethyl)phenyl)]-2H-benzotriazole.

6. The UV/HEVL-filtering silicone hydrogel contact lens of claim 4, wherein the first HEVL-absorbing benzotriazole-containing vinylic monomer is 2-{2′-Hydroxy-3′-tert-butyl-5′-[3′-methacryloyloxypropoxy]phenyl}-5-chloro-2H-benzotriazole (UV28).

7. The UV/HEVL-filtering silicone hydrogel contact lens of claim 6, wherein the second HEVL-absorbing benzotriazole-containing vinylic monomer is 2-[2′-Hydroxy-3′-tert-butyl-5′-(3′-acryloyloxypropoxy)phenyl]-5-trifluoromethyl-2H-benzotriazole (UV23).

8. The UV/HEVL-filtering silicone hydrogel contact lens of claim 7, wherein the bulk silicone hydrogel material in dried state comprises from about 1.2% to about 3.5% by weight of all components (3), (4) and (5).

9. The UV/HEVL-filtering silicone hydrogel contact lens of claim 8, wherein weight ratio of component (4) over component (5) is from about 0.25 to about 2.5.

10. The UV/HEVL-filtering silicone hydrogel contact lens of claim 9, wherein said at least one hydrophilic vinylic monomer comprises: (1) an alkyl (meth)acrylamide selected from the group consisting of (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, and combinations thereof; (2) a hydroxyl-containing acrylic monomer selected from the group consisting of N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate, di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, and combinations thereof; (3) a carboxyl-containing acrylic monomer selected from the group consisting of 2-(meth)acrylamidoglycolic acid, (meth)acrylic acid, ethylacrylic acid, 3-(meth)acrylamidopropionic acid, 5-(meth)acrylamidopentanoic acid, 4-(meth)acrylamidobutanoic acid, 3-(meth)acrylamido-2-methylbutanoic acid, 3-(meth)acrylamido-3-methylbutanoic acid, 2-(meth)acrylamido-2methyl-3,3-dimethyl butanoic acid, 3-(meth)acrylamidohaxanoic acid, 4-(meth)acrylamido-3,3-dimethylhexanoic acid, and combinations thereof; (4) an amino-containing acrylic monomer selected from the group consisting of N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-3-aminopropyl (meth)acrylamide, N-3-methylaminopropyl (meth)acrylamide, N-3-dimethylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-ethylaminopropyl (meth)acrylate, 3-amino-2-hydroxypropyl (meth)acrylate, trimethylammonium 2-hydroxy propyl (meth)acrylate hydrochloride, dimethylaminoethyl (meth)acrylate, and combinations thereof; (5) an N-vinyl amide monomer selected from the group consisting of N-vinylpyrrolidone, N-vinyl-3-methyl-2-pyrrolidone, N-vinyl-4-methyl-2-pyrrolidone, N-vinyl-5-methyl-2-pyrrolidone, N-vinyl-6-methyl-2-pyrrolidone, N-vinyl-3-ethyl-2-pyrrolidone, N-vinyl-4,5-dimethyl-2-pyrrolidone, N-vinyl-5,5-dimethyl-2-pyrrolidone, N-vinyl-3,3,5-trimethyl-2-pyrrolidone, N-vinyl piperidone, N-vinyl-3-methyl-2-piperidone, N-vinyl-4-methyl-2-piperidone, N-vinyl-5-methyl-2-piperidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl caprolactam, N-vinyl-3-methyl-2-caprolactam, N-vinyl-4-methyl-2-caprolactam, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinyl-N-methyl acetamide, N-vinyl formamide, N-vinyl acetamide, N-vinyl isopropylamide, N-vinyl-N-ethyl acetamide, N-vinyl-N-ethyl formamide, and mixtures thereof; (6) a methylene-containing pyrrolidone monomer selected from the group consisting of 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, and combinations thereof; (7) an acrylic monomer having a C₁-C₄ alkoxyethoxy group and selected from the group consisting of ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a number average molecular weight of up to 1500, methoxy-poly(ethylene glycol)ethyl (meth)acrylamide having a number average molecular weight of up to 1500, and combinations thereof; (8) a vinyl ether monomer selected from the group consisting of ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol) methyl vinyl ether, tri(ethylene glycol) methyl vinyl ether, tetra(ethylene glycol) methyl vinyl ether, poly(ethylene glycol) methyl vinyl ether, and combinations thereof; (9) an allyl ether monomer selected from the group consisting of ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol) methyl allyl ether, tri(ethylene glycol) methyl allyl ether, tetra(ethylene glycol) methyl allyl ether, poly(ethylene glycol) methyl allyl ether, and combinations thereof; (10) a phosphorylcholine-containing vinylic monomer selected from the group consisting of (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)-ethylphosphate, 3-[(meth)acryloylamino]propyl-2′-(trimethylammonio)ethylphosphate, 4-[(meth)acryloylamino]butyl-2′-(trimethylammonio)ethylphosphate, 5-((meth)acryloyloxy)pentyl-2-(trimethylammonio)ethyl phosphate, 6-((meth)acryloyloxy)hexyl-2′-(trimethylammonio)-ethylphosphate, 2-((meth)acryloyloxy)ethyl-2′-(triethylammonio)ethylphosphate, 2-((meth)acryloyloxy)ethyl-2-(tripropylammonio)ethylphosphate, 2-((meth)acryloyloxy)ethyl-2′-(tributylammonio)ethyl phosphate, 2-((meth)acryloyloxy)propyl-2′-(trimethylammonio)-ethylphosphate, 2-((meth)acryloyloxy)butyl-2′-(trimethylammonio)ethylphosphate, 2-((meth)acryloyloxy)pentyl-2′-(trimethylammonio)ethylphosphate, 2-((meth)acryloyloxy)hexyl-2′-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)-ethylphosphate, 2-(vinylcarbonylamino)ethyl-2′-(trimethylammonio)ethylphosphate, 2-(allyloxycarbonylamino)ethyl-2′-(trimethylammonio)ethyl phosphate, 2-(butenoyloxy)ethyl-2′-(trimethylammonio)ethylphosphate, and combinations thereof; (11) allyl alcohol; (12) N-2-hydroxyethyl vinyl carbamate; (13) N-carboxyvinyl-R-alanine; (14) N-carboxyvinyl-α-alanine; (15) or combinations thereof.

11. The UV/HEVL-filtering silicone hydrogel contact lens of claim 10, wherein the bulk silicone hydrogel material comprises repeating units of at least one siloxane-containing vinylic monomer selected from the group consisting of a vinylic monomer having a bis(trialkylsilyloxy)alkylsilyl group, a vinylic monomer having a tris(trialkylsilyloxy)silyl group, a polysiloxane vinylic monomer, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, and combinations thereof.

12. The UV/HEVL-filtering silicone hydrogel contact lens of claim 11, wherein the bulk silicone hydrogel material comprises repeating units of said at least one polysiloxane vinylic crosslinker.

13. The UV/HEVL-filtering silicone hydrogel contact lens of claim 12, wherein said at least one polysiloxane vinylic crosslinker comprises a di-(meth)acryloyloxy-terminated polysiloxane vinylic crosslinker having dimethylsiloxane units and hydrophilized siloxane units each having one methyl substituent and one monovalent C₄-C₄₀ organic radical substituent having 2 to 6 hydroxyl groups.

14. The UV/HEVL-filtering silicone hydrogel contact lens of claim 12, wherein said at least one polysiloxane vinylic crosslinker comprises: (i) a vinylic crosslinker which comprises one sole polydiorganosiloxane segment and two terminal ethylenically-unsaturated groups selected from the group consisting of (meth)acryloyloxy groups, (meth)acryloylamino groups, vinyl carbonate groups, vinylcarbamate groups; and/or (ii) a chain-extended polysiloxane vinylic crosslinker which comprises at least two polydiorganosiloxane segment and a covalent linker between each pair of polydiorganosiloxane segments and two two terminal ethylenically-unsaturated groups selected from the group consisting of (meth)acryloyloxy groups, (meth)acryloylamino groups, vinyl carbonate groups, vinylcarbamate groups.

15. The UV/HEVL-filtering silicone hydrogel contact lens of claim 12, wherein the UV/HEVL-filtering silicone hydrogel contact lens when being fully hydrated has: an oxygen permeability of at least 60 barrers (at about 35° C.); an elastic modulus of about 1.5 MPa or less (at a temperature of from 22° C. to 28° C.); a water content of from about 15% to about 70% (at a temperature of from 22° C. to 28° C.); or combinations thereof.

16. The UV/HEVL-filtering silicone hydrogel contact lens of claim 15, wherein the bulk silicone hydrogel material further comprises repeating units of at least one non-silicone vinylic crosslinker, repeating units of at least one hydrophobic non-silicone vinylic monomer.

17. A method for producing HEVL-filtering silicone hydrogel contact lenses, comprising the steps of:
(I) obtaining a mold, wherein the mold has a first mold half with a first molding surface defining the anterior surface of a contact lens and a second mold half with a second molding surface defining the posterior surface of the contact lens, wherein said first and second mold halves are configured to receive each other such that a cavity is formed between said first and second molding surfaces;
(II) introducing a polymerizable composition into the cavity, wherein the polymerizable composition comprises (1) at least one hydrophilic vinylic monomer, (2) at least one siloxane-containing vinylic monomer and/or at least one polysiloxane vinylic crosslinker, (3) at least one UV-absorbing vinylic monomer having an UV absorption peak at a wavelength of from 280 nm and 380 nm, (4) a first HEVL-absorbing benzotriazole-containing vinylic monomer having a first HEVL absorption peak at a wavelength of from 410 nm and 420 nm, (5) a second HEVL-absorbing benzotriazole-containing vinylic monomer that has a second HEVL absorption peak at a wavelength of from 415 nm and 425 nm, (6) from about 100 ppm to about 350 ppm of a polymerizable blue dye, (7) from about 0.2% to about 1.5% by weight of at least one free-radical initiator, and (8) optionally at least one component selected from the group consisting of at least one hydrophobic non-silicone vinylic monomer, at least one non-silicone vinylic crosslinker, a leachable lubricant, a leachable tear-stabilizing agent, and combinations thereof, wherein said components (3), (4) and (5) are present in the polymerizable composition in amounts and at a ratio for rendering the UV/HEVL-filtering contact lens to have a UVA % T of less than 5%, UVB % T of about 1% or less, a HEVL % T of about 35% or less, a % T at 410 nm of about 15% or less, a % T at 430 nm of about 60% or less, a % T at 450 nm of about 85% or greater, and a color expressed with a*≤−5 and b*≤+18; and
(III) curing the polymerizable composition in the mold to form a UV/HEVL-filtering silicone hydrogel contact lens precursor; removing the UV/HEVL-filtering silicone hydrogel contact lens precursor from the mold; and
(IV) subjecting the UV/HEVL-filtering silicone hydrogel contact lens precursor to one or more post-molding processes selected from the group consisting of extraction, hydration, surface treatment, packaging, sterilization, and combinations thereof.

18. The method of claim 17, wherein said at least one polymerizable blue dye is 1,4-bis((2-methoxyethyl)amino)-anthraquinone and/or 1,4-bis(4-(2-methacryloxyethyl)phenylamino)-anthraquinone, wherein said at least one UV-absorbing vinylic monomer comprises 2-(2′-hydroxy-5′-vinylphenyl)-2H-benzotriazole, 2-(2′-hydroxy-5′-methacryloxyphenyl)-2H-benzotriazole, 2-(2′-hydroxy-5′-acryloyloxyphenyl)-2H-benzotriazole, 2-[2′-hydroxy-5′-(2-methacryloxyethyl)phenyl)]-2H-benzotriazole (Norbloc), 2-[2′-hydroxy-5′-(2-acryloxyethyl)phenyl)]-2H-benzotriazole, 2-(2′-hydroxy-5′-methacryloxypropyl-phenyl)-2H-benzotriazole, 2-(2′-hydroxy-5′-acryloxypropylphenyl)-2H-benzotriazole, or combinations thereof, wherein the first HEVL-absorbing benzotriazole-containing vinylic monomer is 2-{2′-Hydroxy-3′-tert-butyl-5′-[3′-methacryloyloxypropoxy]phenyl}-5-chloro-2H-benzotriazole (UV28), wherein the second HEVL-absorbing benzotriazole-containing vinylic monomer is 2-[2′-Hydroxy-3′-tert-butyl-5′-(3′-acryloyloxypropoxy)phenyl]-5-trifluoromethyl-2H-benzotriazole (UV23).

19. The method of claim 18, wherein the polymerizable composition comprises from about 1.2% to about 3.5% by weight of all components (3), (4) and (5) relative to total amount of all polymerizable components, wherein weight ratio of component (4) over component (5) is from about 0.25 to about 2.5.

20. The method of claim 19, wherein said at least one free-radical initiator is a thermal initiator, wherein the polymerizable composition is cured thermally.
